(19) United States
(12) Patent Application Publication
(10) Pub. No.: US 2025/0225756 A1
(43) Pub. Date: Jul. 10, 2025

(54) ELECTRONIC DEVICE AND OPERATING METHOD OF ELECTRONIC DEVICE

(71) Applicant: SAMSUNG ELECTRONICS CO., LTD., Suwon-si (KR)

(72) Inventors: Seungsu SHIN, Suwon-si (KR); Dongjin NA, Suwon-si (KR)

(73) Assignee: SAMSUNG ELECTRONICS CO., LTD., Suwon-si (KR)

(21) Appl. No.: 19/094,132

(22) Filed: Mar. 28, 2025

Related U.S. Application Data
(63) Continuation of application No. PCT/KR2023/011761, filed on Aug. 9, 2023.

(30) Foreign Application Priority Data
Sep. 30, 2022 (KR) 10-2022-0125410
Jan. 9, 2023 (KR) 10-2023-0002851

(51) Int. Cl. G06T 19/20; G06F 3/01

(52) U.S. Cl. CPC G06T 19/20; G06F 3/013; G06T 2219/2004; G06T 2219/2016

(57) ABSTRACT

An electronic device for providing a virtual space, includes: a display; memory storing one or more instructions; and at least one processor operatively connected to the display and the memory, wherein the one or more instructions, which are executed by the at least one processor individually or collectively, cause the electronic device to: receive a first input to select a pattern from a list of patterns for camera moving, display the selected pattern with respect to a first avatar in the virtual space, and capture an image of the virtual space based on the first avatar moving along the selected pattern.

### CROSS-REFERENCE TO RELATED APPLICATIONS

This application is a by-pass continuation application of International Application No. PCT/KR2023/011761, filed on Aug. 9, 2023, which is based on and claims priority to Korean Patent Application No. 10-2022-0125410, filed on Sep. 30, 2022, and Korean Patent Application No. 10-2023-0002851, filed on Jan. 9, 2023, in the Korean Intellectual Property Office, the disclosures of which are incorporated by reference herein their entireties.

### BACKGROUND

### 1. Field

One or more embodiments relate to an electronic device and operating method of the electronic device, and more particularly, to an electronic device capable of capturing an image of a virtual space through an avatar and an operating method of the electronic device.

### 2. Description of Related Art

Recently, there has been growing interest in next-generation media environments that provide users with the opportunity to experience content in a virtual space that resembles a real space. The ‘metaverse’, in particular, is being spotlighted as a typical service that provides such a virtual space for the user. The term ‘metaverse’ is a compound word of ‘meta’ that means abstraction and ‘universe’ that means the real world and refers to a three-dimensional (3D) virtual world, and a key technology of the metaverse is the extended reality (XR) technology that encompasses virtual reality (VR), augmented reality (AR) and mixed reality (MR). There are many different ways of implementing a virtual space but they are commonly characterized by the use of virtual 3D images to interact with the user in real-time.

As the metaverse environment expands, the user may perform various activities through an avatar onto which the user projects himself or herself. For example, the metaverse environment may provide an image capturing service that captures images of a virtual space with a virtual camera through the avatar. By moving the avatar, the user may perform an activity of creating captured images according to capturing movements.

### SUMMARY

According to an aspect of the disclosure, an electronic device for providing a virtual space, includes: a display; memory storing one or more instructions; and at least one processor operatively connected to the display and the memory, wherein the one or more instructions, which are executed by the at least one processor individually or collectively, cause the electronic device to: receive a first input to select a pattern from a list of patterns for camera moving, display the selected pattern with respect to a first avatar in the virtual space, and capture an image of the virtual space based on the first avatar moving along the selected pattern.

According to an aspect of the disclosure, a method of an electronic device for providing a virtual space, includes: receiving a first input to select a pattern from a list of patterns for camera moving; displaying the selected pattern about a first avatar in the virtual space; and capturing an image of the virtual space based on the first avatar moving along the selected pattern.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a capturing service providing system, according to an embodiment;

FIG. 2 illustrates a configuration of an electronic device according to an embodiment;

FIG. 3 illustrates an example of an operating method of an electronic device, according to an embodiment;

FIG. 4 illustrates an operating method between a server and an electronic device for providing a pattern providing service for camera moving, according to an embodiment;

FIG. 5 illustrates operations of a server and an electronic device for displaying a pattern selected from a list of patterns in a pattern providing service, according to an embodiment;

FIGS. 6A and 6B illustrate operations of an electronic device for controlling the location of a pattern in a pattern providing service, according to an embodiment;

FIGS. 7A and 7B illustrate operations of an electronic device for controlling the direction of a pattern in a pattern providing service, according to an embodiment;

FIGS. 8A and 8B illustrate operations of an electronic device for controlling the central axis of a pattern in a pattern providing service, according to an embodiment;

FIGS. 9A and 9B illustrate operations of an electronic device for controlling the size of a pattern in a pattern providing service, according to an embodiment;

FIGS. 10A and 10B illustrate operations of an electronic device for displaying a customized pattern and a preview screen, according to an embodiment;

FIGS. 11A and 11B illustrate operations of an electronic device for displaying a customized pattern and a preview screen, according to an embodiment;

FIG. 12 illustrates operations of an electronic device for capturing an image of a virtual space according to a customized pattern in a pattern providing service, according to an embodiment;

FIG. 13 illustrates an operating method between a server and a plurality of electronic devices for providing a captured screen sharing service, according to an embodiment;

FIG. 14 illustrates operations of a plurality of electronic devices that share captured screens, according to an embodiment;

FIG. 15 illustrates an operating method between a server and a plurality of electronic devices that share captured screens in a captured screen sharing service, according to an embodiment;

FIGS. 16A, 16B, and 16C illustrate operations of a plurality of electronic devices that share captured screens, according to an embodiment;

FIG. 17 illustrates an operating method of an electronic device for providing a pattern providing service and a captured screen sharing service, according to an embodiment;

FIG. 18 illustrates a configuration of an electronic device, according to an embodiment; and

FIG. 19 illustrates a configuration of a server, according to an embodiment.

### DETAILED DESCRIPTION

Throughout the present disclosure, the expression “at least one of a, b or c” indicates only a, only b, only c, both a and b, both a and c, both b and c, all of a, b, and c, or variations thereof.

Embodiments of the disclosure will now be described with reference to accompanying drawings to assist those of ordinary skill in the art in readily implementing them. However, the embodiments of the present disclosure may be implemented in many different forms, and not limited to example embodiments as will be discussed herein.

The terms are selected as common terms widely used now, taking into account principles of the disclosure, which may, however, depend on intentions of those of ordinary skill in the art, judicial precedents, emergence of new technologies, and the like. Therefore, the terms may be construed by their names, or may be defined based on their meanings and descriptions throughout the present disclosure.

The terminology as used herein is only used for describing particular embodiments of the disclosure and not intended to limit the present disclosure.

The term “include (or including)” or “comprise (or comprising)” is inclusive or open-ended and does not exclude additional, unrecited elements or method steps. Each of terms “unit”, “module”, “block”, etc., as used herein, represents a component, device, or a computer code for handling at least one function or operation, and may be implemented in hardware, software, or a combination of the hardware and the software.

Embodiments of the disclosure will now be described in detail with reference to accompanying drawings to be readily practiced by those of ordinary skill in the art. However, the embodiments of the present disclosure may be implemented in many different forms, and are not limited to those discussed herein. In the drawings, parts unrelated to the description are omitted for clarity, and like numerals refer to like elements throughout the specification.

In embodiments of the present disclosure, the term ‘user’ refers to a person who controls a system, a function or an operation, including a developer, an administrator, or an installation engineer.

The terms “processor” may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The present disclosure will now be described with reference to accompanying drawings.

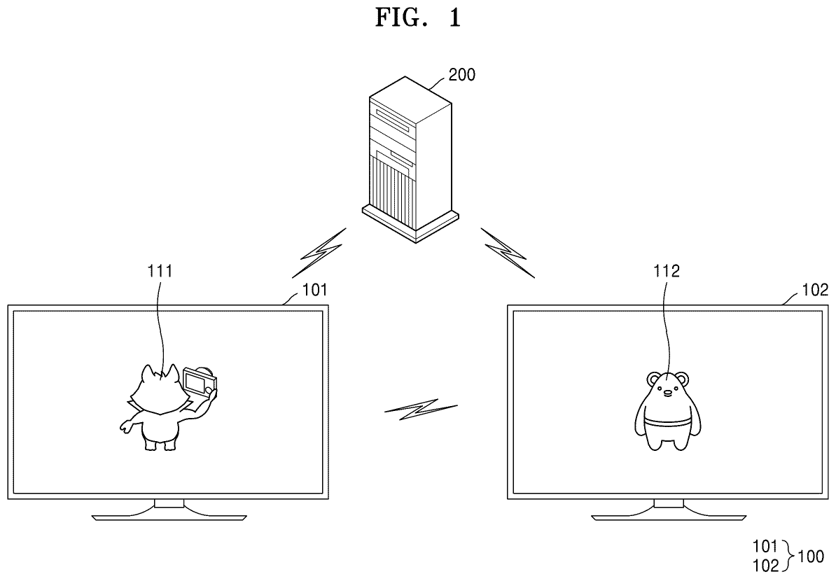

FIG. 1 illustrates a capturing service providing system, according to an embodiment.

Referring to FIG. 1, the capturing service providing system may include a plurality of electronic devices 101 and 102 and a server 200. In an embodiment, the plurality of electronic devices 101 and 102 may provide a capturing service. In an embodiment, the capturing service may relate to a feature of capturing an image of a virtual space based on a location and gaze of an avatar in the virtual space. The plurality of electronic devices 101 and 102 may be collectively referred to as an electronic device 100. The plurality of electronic devices 101 and 102 may be referred to as a first electronic device 101 and a second electronic device 102, respectively.

In an embodiment, each of the plurality of electronic devices 101 and 102 may be capable of outputting an image. In an embodiment, the plurality of electronic devices 101 and 102 may be implemented as various types of electronic devices each including a display. Each of the plurality of electronic devices 101 and 102 may be of a fixed type or a mobile type, and may be a digital television (TV) capable of receiving digital broadcast, without being limited to the above examples.

Each of the plurality of electronic devices 101 and 102 may include at least one of a desktop, a smartphone, a tablet personal computer (tablet PC), a mobile phone, a video phone, an e-book reader, a laptop PC, a netbook computer, a digital camera, a personal digital assistant (PDA), a portable multimedia player (PMP), a camcorder, a navigation system, a wearable device, a smart watch, a home network system, a security system, a medical device, or a head mounted display (HMD).

In an embodiment, the electronic device 100 may provide various virtual space contents. The electronic device 100 may be one of the plurality of electronic devices 101 and 102. For example, the electronic device 100 may receive and display a virtual space content provided from the server 200. For example, the server 200 may generate and transmit the virtual space content to the electronic device 100 over a communication network. For example, the server 200 may generate an avatar corresponding to the user of the electronic device 100 in the virtual space content, and transmit them to the electronic device 100. The electronic device 100 may display the virtual space content as well as the avatar corresponding to the user. In an embodiment, the electronic device 100 may generate and output the virtual space content by running an application installed in the electronic device 100.

The server 200 may generate and provide the virtual space content such that users of various clients may access the virtual space content. The server 200 may generate and provide avatars which reflect the users of various clients. The server 200 may provide the virtual space content to the electronic device 100, which is an example of a client, and in response to an input of the user of the electronic deice 100, manage the coordinates of an object (e.g., an avatar) in the virtual space. In other words, the server 200 may allow interactions between the user in a real space and the object in the virtual space.

In an embodiment, the capturing service may include a pattern providing service for providing a pattern for camera moving. In the present disclosure, the pattern for camera moving (hereinafter, referred to as a ‘camera moving pattern’ or a ‘pattern’) may refer to or may correspond to a capturing movement line that is set, in advance, to capture the virtual space, a capturing sequence, camera work, camera tracking, etc., like a camera rail that assists in image capturing. In an embodiment, the electronic device 100 and the server 200, which are involved in a capturing service providing system, may capture the virtual space along the camera moving pattern generated through the pattern providing service. In an embodiment, the electronic device 100 may synchronize a list of patterns provided from the server 200, and display the list of patterns. In an embodiment, the electronic device 100 may receive a user input to select one of the patterns in the list, and display the selected pattern in the virtual space. In an embodiment, the electronic device 100 may move the avatar along the selected pattern to capture a virtual space based on the location of the avatar and the gaze of the avatar.

In an embodiment, the electronic device 100 may operate the capturing avatar by applying the camera moving pattern set in advance through the pattern providing service. As the user may predict a capturing movement according to the list of representative camera moving patterns, a procedure for directly making the capturing movement line may be omitted. In an embodiment, the electronic device 100 may capture the virtual space by operating the capturing avatar along the camera moving pattern.

In an embodiment, the electronic device 100 may generate a customized pattern based on a user input to set a state of the pattern. In an embodiment, the electronic device 100 may move the avatar along the customized pattern to capture the virtual space based on the location of the avatar and the gaze of the avatar. In an embodiment, the electronic device 100 may set a user customized state in the camera moving pattern set in advance through the pattern providing service. The user may generate the camera moving pattern having a desired location, size, direction, etc., even without making a capturing movement line in person.

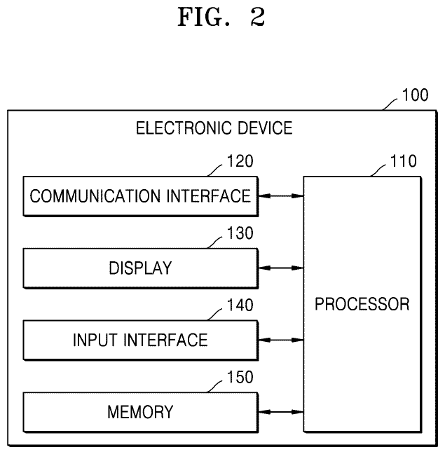

In an embodiment, the electronic device 100 may set the user customized state in the preset pattern to operate the avatar even without operating the avatar in various movement lines to capture the virtual space. Accordingly, the user may predict the capturing movement line according to the list of representative moving patterns without operating the avatar in person. Furthermore, as the avatar moves along the pattern without deviating from the customized pattern, the user may capture the virtual space more conveniently. This will be described in detail in connection with FIGS. 2 to 12.

In an embodiment, the capturing service may include a captured screen sharing service for sharing captured screens between the plurality of electronic devices 101 and 102. In an embodiment, the plurality of electronic devices 101 and 102 may provide the captured screen sharing service. The plurality of electronic devices 101 and 102 that provide the captured screen sharing service may share the captured screen or receive the captured screen. For example, when the first electronic device 101 shares the captured screen through the server 200, the second electronic device 102 may receive the captured screen through the server 200. The second electronic device 102 may display the received captured screen based on information of the avatar of the first electronic device 101. This will be described in detail in connection with FIGS. 2 and 13 to 16.

In the present disclosure, when the first electronic device 101 includes a capturing avatar that captures the virtual space, the capturing avatar may be referred to as a first avatar 111. Furthermore, when the second electronic device 102 includes a sharing avatar, which receives a screen captured by the first avatar 111, the sharing avatar may be referred to as a second avatar 112.

FIG. 2 illustrates a configuration of an electronic device according to an embodiment.

Referring to FIG. 2, the electronic device 100 according to an embodiment may include a processor 110, a communication interface 120, a display 130, an input interface 140, and a memory 150.

In an embodiment, the communication interface 120 may connect the electronic device 100 to an external device such as the server 200, a mobile terminal, etc., under the control of the processor 110. For example, the communication interface 120 may include a Wi-Fi module, a Bluetooth module, an infrared communication module, a wireless communication module, a LAN module, an Ethernet module, a wired communication module, etc. In this case, each communication module may be implemented in the form of at least one hardware chip. The wireless communication module may include at least one communication chip for performing communication according to various wireless communication standards such as ZigBee, third generation (3G), third generation partnership project (3GPP), long term evolution (LTE), LTE advanced (LTE-A), fourth generation (4G), fifth generation (5G), etc.

In an embodiment, the communication interface 120 may receive virtual space contents including an avatar from the server 200 under the control of the processor 110. In an embodiment, the communication interface 120 may receive a list of preset patterns from the server 200 under the control of the processor 110. In an embodiment, the communication interface 120 may share a captured screen with another electronic device under the control of the processor 110.

In an embodiment, the display 130 may convert an image signal, a data signal, an on-screen display (OSD) signal, a control signal, etc., processed by the processor 110 into a driving signal, and display an image according to the driving signal.

In an embodiment, the display 130 may display a virtual space including an avatar under the control of the processor 110. In an embodiment, under the control of the processor 110, the display 130 may display the list of patterns, a selected pattern in the virtual space, or capturing effects. In an embodiment, under the control of the processor 110, the display 130 may display a user interface (UI) for providing a captured screen sharing service (or a sharing service UI), an inquiry UI for inquiring whether to agree to sharing the captured screen, a notification UI for notifying the progress of the sharing of the captured screen, a preview screen of the captured screen, etc. The user is able to interact with the electronic device 100 and the server 200 through a UI displayed on the display 130.

In an embodiment, the input interface 140 may receive a user input to control the electronic device 100. The input interface 140 may include a touch panel for detecting a touch of the user, a button, a wheel, a keyboard and a dome switch for receiving a user input, a mike for voice recognition, a motion detection sensor for sensing a motion, etc. In an embodiment, the input interface 140 may receive a user input through an external control device, e.g., a remote controller.

In an embodiment, the memory 150 may store various data, programs, or applications for driving and controlling the electronic device 100. In an embodiment, the program stored in the memory 150 may include one or more instructions. The program (one or more instructions) or the application stored in the memory 150 may be executed by the processor 110.

In an embodiment, the memory 150 may include at least one type of storage media including a flash memory, a hard disk, a multimedia card micro type memory, a card type memory (e.g., SD or XD memory), a random access memory (RAM), a static RAM (SRAM), a read-only memory (ROM), an electrically erasable programmable ROM (EEPROM), a programmable ROM (PROM), a magnetic memory, a magnetic disk, and an optical disk.

In an embodiment, the processor 110 may control general operation of the electronic device 100 and signal flows between the internal components of the electronic device 100, and process data.

In an embodiment, the processor 110 may include at least one of a central processing unit (CPU), a graphic processing unit (GPU) or a video processing unit (VPU). In an embodiment, the processor 110 may be implemented in the form of a system on chip (SoC) that integrates at least one of the CPU, the GPU and the VPU. In an embodiment, the processor 110 may further include a neural processing unit (NPU).

In an embodiment, the processor 110 may execute one or more instructions stored in the memory 150 to control operations of the electronic device 100 to be performed.

In an embodiment, the processor 110 may receive an input to select a pattern from the list of patterns for camera moving. In an embodiment, the processor 110 may display the selected pattern based on the first avatar in the virtual space. In an embodiment, the processor 110 may generate a customized pattern based on an input to set a state of the pattern. In an embodiment, the processor 110 may capture the virtual space based on the first avatar that moves along the customized pattern.

In an embodiment, the electronic device 100 may receive an input to select a pattern from the list of patterns for camera moving, display the selected pattern based on the first avatar in the virtual space, and capture the virtual space based on the first avatar moving along the selected pattern. In an embodiment of the present disclosure, the electronic device 100 may operate without operation S330. For example, the electronic device 100 may not receive the input to set a state of the pattern. For example, the electronic device 100 may capture the virtual space through the pattern selected from the list of patterns. In this case, the selected pattern may have a state of the pattern provided by default from the server 200.

In an embodiment, the processor 110 may receive a list of preset patterns from the server 200 through the communication interface 120. In an embodiment, the processor 110 may control the display 130 to display the list of patterns.

In an embodiment, the processor 110 may display the selected pattern in the virtual space based on the location or gaze of the first avatar. In an embodiment, the processor 110 may perform capturing based on screen information regarding the gaze of the first avatar.

In an embodiment, the processor 110 may perform one of an operation of controlling the location of the pattern based on an input to change the location of the first avatar included in the virtual space, an operation of controlling the direction of the pattern based on an input to change the gaze direction of the first avatar included in the virtual space, an operation of controlling the central axis of the pattern based on an input to change the location of the first avatar included in the virtual space, and an operation of controlling the size of the pattern based on an input to enlarge, reduce or partially delete the pattern.

In an embodiment, the processor 110 may highlight a portion of the pattern, which overlaps an obstacle in the virtual space. In an embodiment, the processor 110 may control the portion of the pattern to be deleted.

In an embodiment, the processor 110 may control the display 130 to display a first screen that displays a virtual space according to the gaze of the first avatar and a second screen that displays a virtual space including the location of the first avatar, based on an input to set a state of the pattern.

In an embodiment, the processor 110 may control the first avatar to move without deviating from the customized pattern based on an input to control a movement direction of the first avatar.

In an embodiment, based on an input to set a capturing effect, the processor 110 may process the capturing effect. The capturing effect may include one of flashing, moving speed adjustment, lighting, camera swaying, exposure, and zoom-in/zoom-out.

In an embodiment, the processor 110 may receive an input to select the second avatar for sharing the captured screen. In an embodiment, the processor 110 may transmit, to the server 200 through the communication interface 120, a request signal to invite the second avatar. In an embodiment, based on receiving of an input signal to agree to sharing the captured screen from the server 200 through the communication interface 120, the processor 110 may share the captured screen.

In an embodiment, the processor 110 may transmit captured screen information to the server 200 through the communication interface 120. The captured screen information may include one of the location of the first avatar, the gaze direction of the first avatar, the movement direction of the first avatar, and location information of the first avatar moving along the customized pattern.

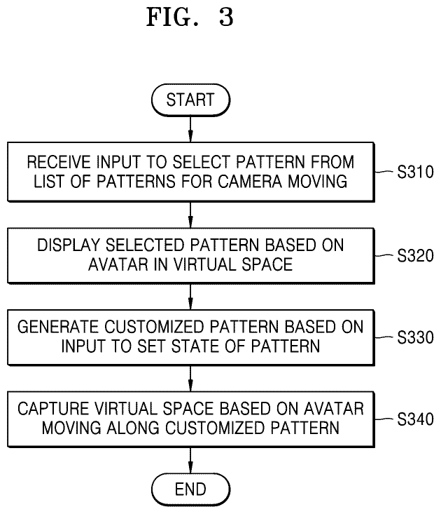

FIG. 3 illustrates an example of an operating method of an electronic device, according to an embodiment.

Referring to FIG. 3, in operation S310, the electronic device 100 according to an embodiment may receive an input to select a pattern from a list of patterns for camera moving.

In an embodiment, the electronic device 100 may receive a list of preset patterns from the server 200 through the communication interface 120. In an embodiment, the electronic device 100 may control the display 130 to display the list of patterns.

For example, the electronic device 100 may receive the latest list of patterns from the server 200, and periodically update the list of patterns. For example, the camera moving pattern may include a 360-degree moving pattern, a curved moving pattern, a linear moving pattern, an 8-shaped moving pattern, etc. For example, the 360-degree moving pattern may be used to capture an object in 360 degrees. For example, the 8-shaped moving pattern may be used to capture an object in the shape of 8.

The user may select one of the patterns in the list displayed on the electronic device 100. In an embodiment, the electronic device 100 may receive an input to select one of the patterns in the list through the input interface 140. In an embodiment, the electronic device 100 may execute one or more instructions stored in the memory 150 to select a pattern by processing the user input.

In operation S320, the electronic device 100 may display the selected pattern based on an avatar in the virtual space.

In the present disclosure, the avatar may refer to an avatar that capture (an object in) the virtual space. For example, the gaze of the avatar may correspond to a capturing camera. In another example, the avatar may be in a state of carrying the image capturing camera. The avatar may be provided from the server 200. The server 200 may generate an avatar that reflects the user of the electronic device 100 in the virtual space, and provide the avatar to the electronic device 100.

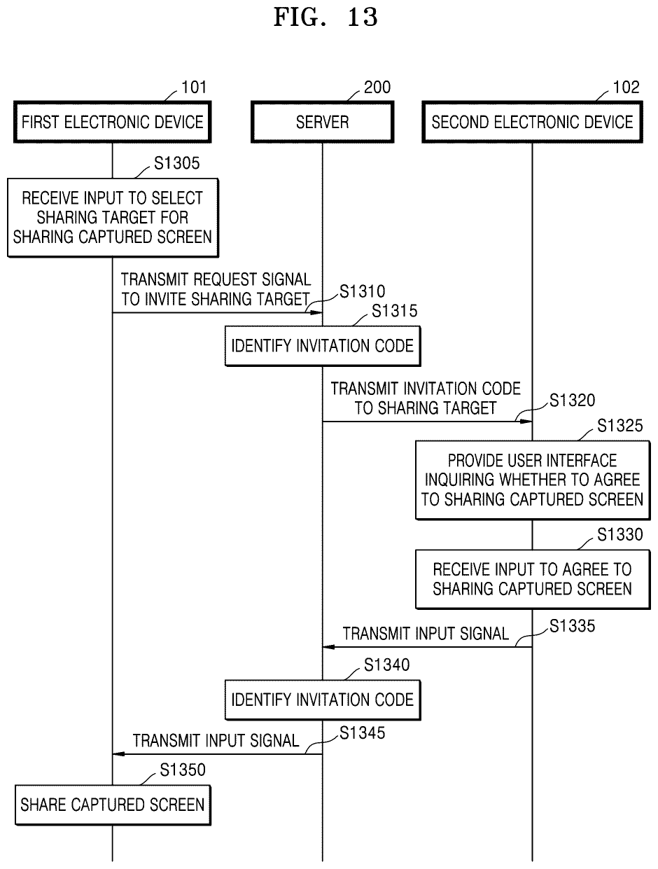

In an embodiment, the electronic device 100 may share a screen captured by the avatar with another electronic device. In this case, when the avatar of the electronic device 100 that shares the captured screen is the first avatar, the avatar of the other electronic device that receives the shared captured screen may be the second avatar. This will be described in connection with FIG. 13.

In an embodiment, the electronic device 100 may display the selected pattern in a virtual space based on the position or gaze of the avatar in the virtual space.

For example, the electronic device 100 may display the selected pattern in the virtual space based on the location of the avatar. For example, when the electronic device 100 displays a third-person virtual space according to the location of the avatar, a pattern selected based on the location of the avatar may be displayed in the virtual space.

For example, the electronic device 100 may display the selected pattern in the virtual space based on the gaze of the avatar. For example, when the electronic device 100 displays a first-person virtual space according to the gaze of the avatar, a pattern selected based on the gaze of the avatar may be displayed in the virtual space.

In operation S330, the electronic device 100 according to an embodiment may generate a customized pattern based on an input to set a state of the pattern. For example, a state of the pattern may include one of a location of the pattern, a direction of the pattern, a central axis of the pattern and a size of the pattern.

The user may set a state of the pattern displayed on the electronic device 100. In an embodiment, the electronic device 100 may receive a user input to set a state of the pattern through the input interface 140. In an embodiment, the electronic device 100 may control the state of the pattern by processing the user input.

In an embodiment, the electronic device 100 may control the location of the pattern based on an input to change the location of the avatar included in the virtual space.

In an embodiment, the electronic device 100 may control the direction of the pattern based on an input to change the gaze direction of the avatar included in the virtual space.

In an embodiment, the electronic device 100 may control the central axis of the pattern based on an input to change the location of the avatar included in the virtual space.

In an embodiment, the electronic device 100 may control the size of the pattern based on an input to enlarge, reduce or partially delete the pattern.

In an embodiment, the electronic device 100 may control a portion of the pattern overlapping the virtual space to be deleted.

In an embodiment, the electronic device 100 may generate a customized pattern by controlling a state of the pattern.

In an embodiment, the electronic device 100 may display the state of the pattern on a preview screen based on an input to set the state of the pattern. In an embodiment, the electronic device 100 may generate the customized pattern that is being set in a preview screen before image capturing so that the user intuitively sets a customized pattern.

For example, the electronic device 100 may control the display 130 to display a first screen that displays a virtual space according to the gaze of the avatar and a second screen that displays a virtual space including the location of the avatar. For example, the first screen may be a first-person screen of the avatar, and the second screen may be a third-person screen of the avatar.

In operation S340, the electronic device 100 according to an embodiment may capture the virtual space based on the avatar that is moving along the customized pattern.

In an embodiment, the electronic device 100 may control the avatar to move without deviating from the customized pattern based on an input to control the movement direction of the avatar.

In an embodiment, based on an input to set an image capturing effect, the electronic device 100 may process the image capturing effect. For example, the image capturing effect may include flashing, moving speed adjustment, lighting, camera swaying, exposure, zoom-in/zoom-out, etc.

In an embodiment, the electronic device 100 may perform image capturing based on screen information regarding the gaze of the avatar. For example, the electronic device 100 may store a virtual space located in a direction toward which the avatar gazes. For example, the electronic device 100 may generate and store a captured image based on the screen information of the direction toward which the avatar gazes.

In an embodiment, the electronic device 100 may operate the capturing avatar by setting a user customized state to a preset pattern through a pattern providing service. The user may predict the capturing movement line according to the list of representative moving patterns without operating the avatar in person.

In an embodiment, the electronic device 100 may receive an input to select a pattern from the list of patterns for camera moving, display the selected pattern based on the avatar in the virtual space, and capture the virtual space based on the avatar that is moving along the selected pattern. In an embodiment of the present disclosure, the electronic device 100 may operate without operation S330. For example, the electronic device 100 may not receive the input to set a state of the pattern. For example, the electronic device 100 may capture the virtual space through the pattern selected from the list of patterns. In this case, the selected pattern may have a state of the pattern provided by default from the server 200. In other words, the user may perform image capturing in a pattern provided by default without changing the state of the pattern.

In an embodiment of the present disclosure, an operating method of the electronic device 100 may include receiving an input to select a pattern from the list of patterns for camera moving, displaying the selected pattern based on an avatar in a virtual space, and capturing an image of the virtual space based on the avatar that is moving along the selected pattern.

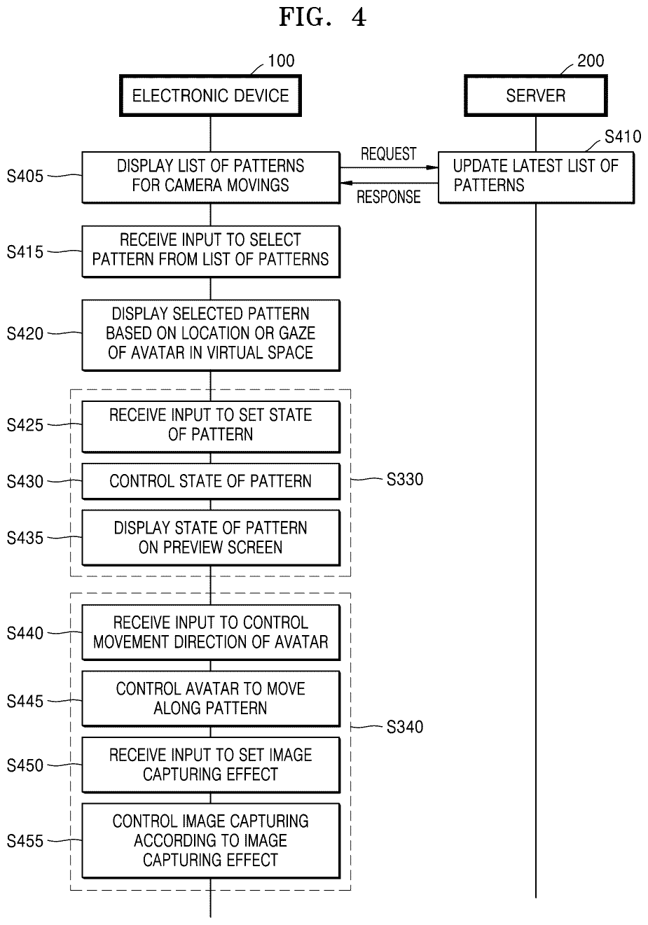

FIG. 4 illustrates an operating method between a server and an electronic device for providing a pattern providing service for camera moving, according to an embodiment.

Referring to FIG. 4, in operation S405, the electronic device 100 according to an embodiment may display a list of patterns for camera moving. In an embodiment, the electronic device 100 may request the list of patterns from the server 200 through the communication interface 120. In an embodiment, the electronic device 100 may periodically receive the latest list of patterns from the server 200. In an embodiment, the electronic device 100 may be synchronized with the server 200.

In an embodiment, the electronic device 100 may display the updated latest list of patterns. For example, the camera moving pattern may include a 360-degree moving pattern, a curved moving pattern, a linear moving pattern, an 8-shaped moving pattern, etc. For example, the camera moving pattern may include moving patterns generated by users of the plurality of electronic devices 101 and 102 as well as the electronic device 100.

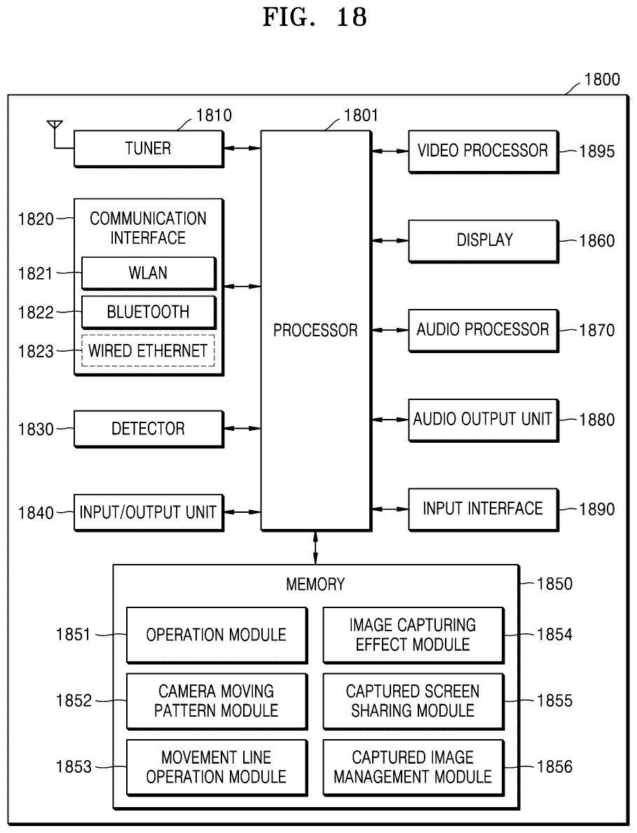

In an embodiment, the processor 110 may execute one or more instructions stored in a camera moving pattern module 1852 (see FIG. 18) to receive the list of patterns and control the display 130 to display the received list of patterns.

In operation S410, the server 200 in an embodiment may update the latest list of patterns. For example, the server 200 may store preset patterns, and store various new patterns received from various clients.

In an embodiment, the server 200 may transmit the latest list of patterns at the request of the electronic device 100. In an embodiment, even without the request of the electronic device 100, the server 200 may periodically transmit the latest list of patterns to the electronic device 100.

In operation S415, the electronic device 100 according to an embodiment may receive an input to select a pattern from the list of patterns.

The user may select one of the patterns in the list displayed on the electronic device 100. In an embodiment, the electronic device 100 may receive an input to select one of the patterns in the list through the input interface 140.

In an embodiment, the processor 110 may execute one or more instructions stored in an operation module 1851 (see FIG. 18) to select a pattern by processing the user input.

In operation S420, the electronic device 100 according to an embodiment may display the selected pattern based on the location or gaze of an avatar in the virtual space. Operation S420 may correspond to operation S320 of FIG. 3.

In an embodiment, the electronic device 100 may display the selected pattern in the virtual space based on the location of the avatar. For example, when the electronic device 100 displays a third-person virtual space according to the location of the avatar, a pattern selected based on the location of the avatar may be displayed in the virtual space. For example, the electronic device 100 may generate the selected pattern centered on the location of the avatar. For example, the electronic device 100 may display the generated pattern on the left/right from the central axis of the avatar.

In an embodiment, the electronic device 100 may display the selected pattern in the virtual space based on the gaze of the avatar. For example, when the electronic device 100 displays a first-person virtual space according to the gaze of the avatar, a pattern selected based on the gaze of the avatar may be displayed in the virtual space. For example, the electronic device 100 may display at least a portion of the pattern to come into view of the avatar.

In an embodiment, the processor 110 may execute one or more instructions stored in the camera moving pattern module 1852 (see FIG. 18) to control the display 130 to display the selected pattern.

Subsequently, the electronic device 100 according to an embodiment may repeatedly perform operations S425, S430 and S435 in a loop until a condition for completion is reached. The electronic device 100 may generate a customized pattern by repeatedly performing operations S425, S430 and S435. In other words, the user may repeatedly interact with the electronic device 100 to set a state of the pattern and generate a customized pattern. Operations S425, S430 and S435 may correspond to operation S330 of FIG. 3.

In operation S425, the electronic device 100 according to an embodiment may receive an input to set a state of the pattern. For example, a state of the pattern may include one of a location of the pattern, a direction of the pattern, a central axis of the pattern and a size of the pattern.

The user may set a state of the pattern displayed on the electronic device 100. In an embodiment, the electronic device 100 may receive a user input to set a state of the pattern through the input interface 140. For example, the electronic device 100 may receive a user input to set a location of the pattern, a direction of the pattern, a central axis of the pattern, or a size of the pattern. In an embodiment, the processor 110 may execute one or more instructions stored in the operation module 1851 (see FIG. 18) to process the user input to set a state of the pattern.

In an embodiment, the electronic device 100 may receive an input to change the location of the avatar included in the virtual space. In an embodiment, the electronic device 100 may receive an input to change the gaze direction of the avatar included in the virtual space. In an embodiment, the electronic device 100 may receive an input to change the location of the avatar included in the virtual space. In an embodiment, the electronic device 100 may receive an input to enlarge, reduce or partially delete the pattern.

In operation S430, the electronic device 100 according to an embodiment may control a state of the pattern. In an embodiment, the electronic device 100 may display the state of the pattern based on an input to set the state of the pattern.

In an embodiment, the electronic device 100 may control the location of the pattern, the direction of the pattern, the central axis of the pattern and the size of the pattern. In an embodiment, the electronic device 100 may control the location of the pattern based on an input to change the location of the avatar included in the virtual space. In an embodiment, the electronic device 100 may control the direction of the pattern based on an input to change the gaze direction of the avatar included in the virtual space. In an embodiment, the electronic device 100 may control the central axis of the pattern based on an input to change the location of the avatar included in the virtual space. In an embodiment, the electronic device 100 may control the size of the pattern based on an input to enlarge, reduce or partially delete the pattern.

In an embodiment, the processor 110 may execute one or more instructions stored in the camera moving pattern module 1852 (see FIG. 18) to control the state of the pattern.

In operation S435, the electronic device 100 according to an embodiment may display the state of the pattern in a preview screen.

In an embodiment, the electronic device 100 may generate the customized pattern that is being set in a preview screen before image capturing so that the user intuitively sets the customized pattern.

In an embodiment, the electronic device 100 may control the display 130 to display a first screen that provides a virtual space according to the gaze of the avatar a second screen that provides a virtual space including the location of the avatar. For example, the first screen may be a first-person screen of the avatar, and the second screen may be a third-person screen of the avatar.

In an embodiment, the electronic device 100 may display the first screen as a full screen and display the second screen as a preview screen in a portion of the first screen.

In an embodiment, the electronic device 100 may display the second screen as a full screen and display the first screen as a preview screen in a portion of the second screen.

For example, when setting a state of the pattern on the first-person screen, the user may not check the overall state of the pattern. In this case, the user may check the overall direction, size, etc., of the pattern through a third-person preview screen. In an embodiment, the preview screen may be arranged at an upper right corner in a size of one fourth, enlarged/reduced or moved by the user.

In an embodiment, the processor 110 may execute one or more instructions stored in the camera moving pattern module 1852 (see FIG. 18) to control the display 130 to display the state of the pattern in a preview screen.

In an embodiment, the electronic device 100 may generate a pattern customized for the user by repeatedly performing operations S425, S430 and S435.

Subsequently, the electronic device 100 according to an embodiment may repeatedly perform operations S440, S45, S450 and S455 in a loop until a condition for completion is reached. The electronic device 100 may perform image capturing based on the gaze of the avatar by repeatedly performing operations S440, S450 and S455. In other words, the user may repeatedly interact with the electronic device 100 to generate a captured image. Operations S440, S445, S450 and S455 may correspond to operation S340 of FIG. 3.

In operation S440, the electronic device 100 according to an embodiment may receive an input to control the movement direction of the avatar. In operation S445, the electronic device 100 according to an embodiment may control the avatar to move along the pattern. In an embodiment, the electronic device 100 may control the avatar to move along the pattern based on an input to control the movement direction of the avatar.

The user may control the movement direction of the avatar. In an embodiment, the electronic device 100 may receive a user input to control the movement direction of the avatar through the input interface 140. For example, the electronic device 100 may receive a user input to select one direction from among right, left, upward and downward directions. For example, the electronic device 100 may control the avatar to move in one direction among the right, left, upward and downward directions along the pattern, based on the user input.

In an embodiment, the electronic device 100 may control the avatar to move without deviating from the pattern based on an input to control the movement direction of the avatar. For example, when the pattern displayed on the electronic device 100 is a linear moving pattern extending to the left and right, the electronic device 100 may control the avatar to not move based on a user input to select an upward direction or a downward direction. In an embodiment, for example, the electronic device 100 may control the avatar to move to the left or right in response to a user input selecting an upward or downward direction. For example, the electronic device 100 may control the avatar to move to the left or right in response to a user input selecting the left or the right.

In an embodiment, the processor 110 may execute one or more instructions stored in the operation module 1851 (see FIG. 18) to process the user input and receive an input to control the movement direction of the avatar. In an embodiment, the processor 110 may execute one or more instructions stored in a movement line operation module 1853 (see FIG. 18) to control the avatar to move along a movement line of the pattern and not to deviate from the pattern.

In operation S450, the electronic device 100 according to an embodiment may receive an input to set an image capturing effect. In operation S455, the electronic device 100 according to an embodiment may control the image capturing according to the image capturing effect. In an embodiment, based on an input to set an image capturing effect, the electronic device 100 may control the image capturing according to the image capturing effect. For example, the image capturing effect may include flashing, moving speed adjustment, lighting, camera swaying, exposure, zoom-in/zoom-out, etc.

The user may select an image capturing effect to be processed for the captured image. In an embodiment, the electronic device 100 may receive a user input to select an image capturing effect through the input interface 140. For example, the electronic device 100 may receive a user input to select a flash effect, and control the flash effect to be processed for the captured image based on the user input.

In an embodiment, the processor 110 may execute one or more instructions stored in the operation module 1851 (see FIG. 18) to process the user input and receive an input to select the image capturing effect. In an embodiment, the processor 110 may execute one or more instructions stored in an image capturing effect module 1854 (see FIG. 18) to process the image capturing effect.

In an embodiment, the electronic device 100 may capture the virtual space based on the avatar that is moving along the customized pattern. For example, the electronic device 100 may store the screen information of the virtual space located in a direction toward which the avatar gazes. For example, the electronic device 100 may store the screen information and generate the captured image.

In an embodiment, the processor 110 may execute one or more instructions stored in a captured image management module 1856 (see FIG. 18) to store the screen information and generate a captured screen or captured image.

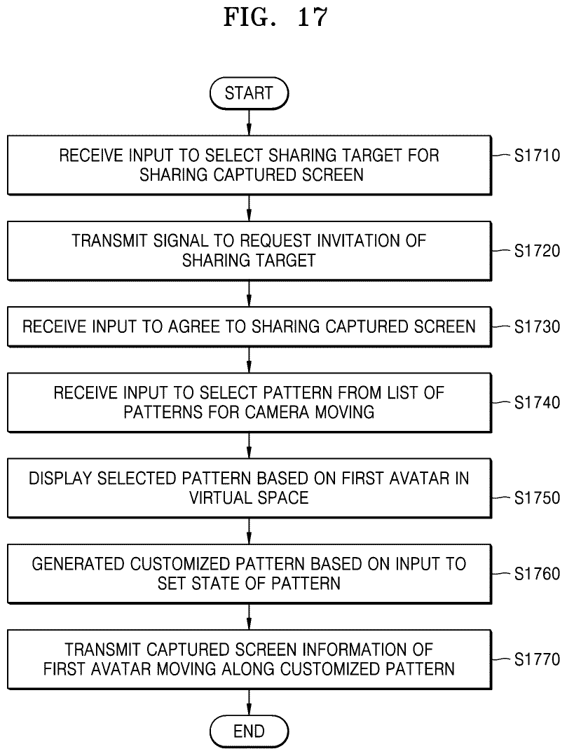

In an embodiment, the electronic device 100 may share the stored screen information with the user of another electronic device, and share the captured screen or captured image with the user of the other electronic device as well. This will be described in detail in connection with FIG. 17.

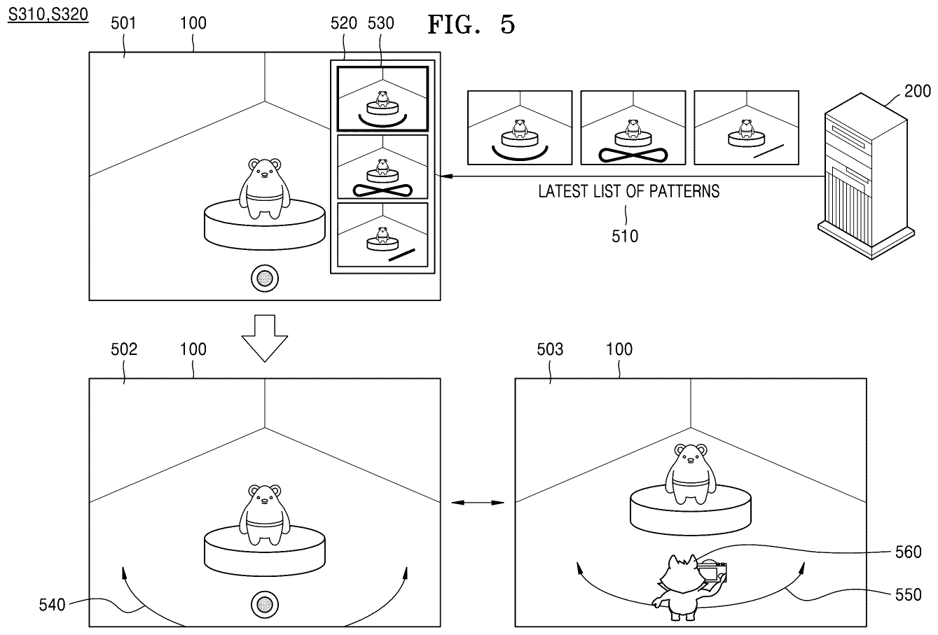

Operations of the electronic device 100 and the server 200 for capturing an image of a virtual space according to a pattern providing service according to an embodiment will now be described with reference to FIGS. 5 to 12.

FIG. 5 illustrates operations of a server and an electronic device for displaying a pattern selected from a list of patterns in a pattern providing service, according to an embodiment. Operations shown in FIG. 5 may correspond to operations S310 and S320 of FIG. 3.

Referring to FIG. 5, the electronic device 100 may display a virtual space screen 501. For example, the electronic device 100 may receive a three dimensional (3D) virtual space from the server 200 and display the 3D virtual space as the two-dimensional (2D) virtual space screen 501. For example, the electronic device 100 may receive, from the server 200, the 2D virtual space screen 501, to which the 3D virtual space is rendered.

In the present disclosure, illustrated is the avatar of the electronic device 100 looking at a target avatar present in the virtual space to be captured. In this case, the electronic device 100 may display the target avatar included in the virtual space screen, and the avatar of the electronic device 100 may capture the target avatar. However, the disclosure is not limited to the above examples. The avatar of the electronic device 100 looks at another object to be captured (e.g., animal, tree, background, etc.) that is present in the virtual space and capture the object.

As shown in FIG. 5, the server 200 may update the latest list of patterns 510 for the electronic device 100. For example, the server 200 may store preset patterns, and store various new patterns received from various clients. The server 200 may transmit the latest list of patterns 510 at the request of the electronic device 100. In an embodiment, even without the request of the electronic device 100, the server 200 may periodically transmit the latest list of patterns 510 to the electronic device 100. For example, the server 200 may transmit the latest list of patterns 510 including a curved moving pattern, a linear moving pattern, an 8-shaped moving pattern, etc.

The electronic device 100 may display a list of patterns 520 on the virtual space scree 501. For example, the electronic device 100 may display the curved moving pattern, the linear moving pattern, the 8-shaped moving pattern, etc., in the list of patterns 520. For example, the camera moving pattern may include moving patterns generated by users of the plurality of electronic devices 101 and 102 as well as the electronic device 100.

The electronic device 100 may receive a user input to select a pattern 530 from the displayed list of patterns 520. In the present disclosure, the pattern 530 is illustrated as a curved moving pattern extending to the left and right.

Subsequently, the electronic device 100 may display a selected pattern 540 or 550 on a virtual space screen 502 or 503 based on a user input selecting the pattern 530. The virtual space screen 502 is a first-person screen that displays a virtual space according to the gaze of an avatar 560, and the virtual space screen 503 is a third-person screen that displays a virtual space including the location of the avatar 560. The avatar 560 may not appear on the virtual space screen 502. The virtual space screen 502 and the virtual space screen 503 may be changed by a choice of the user.

The electronic device 100 may display the selected pattern 540 or 550 on the virtual space screen 502 or 503 based on the location of the avatar 560 or the gaze of the avatar 560.

For example, the selected pattern 540 may be displayed based on the gaze of the avatar 560 on the virtual space screen 502. For example, the electronic device 100 may display the selected pattern 540 to the left/right based on the gaze of the avatar 560. For example, the electronic device 100 may display a curved moving pattern that is symmetric with respect to the center of the avatar 560. The selected pattern 540 displayed on the virtual space screen 502 may be displayed to have only at least a portion of the pattern 540 shown according to the gaze of the avatar 560.

For example, the selected pattern 550 may be displayed based on the location of the avatar 560 on the virtual space screen 503. For example, the electronic device 100 may generate the selected pattern 550 centered on the location of the avatar 560. For example, the electronic device 100 may display a curved moving pattern that is symmetric with respect to the avatar 560. The selected pattern 550 displayed on the virtual space screen 503 may be displayed to have all the pattern 550 shown with the avatar 560.

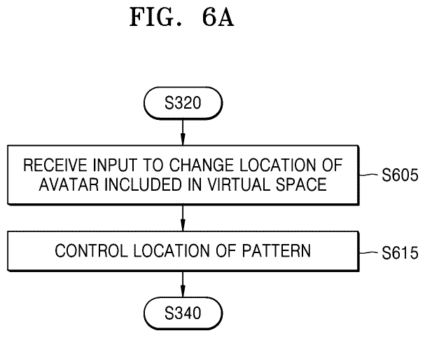

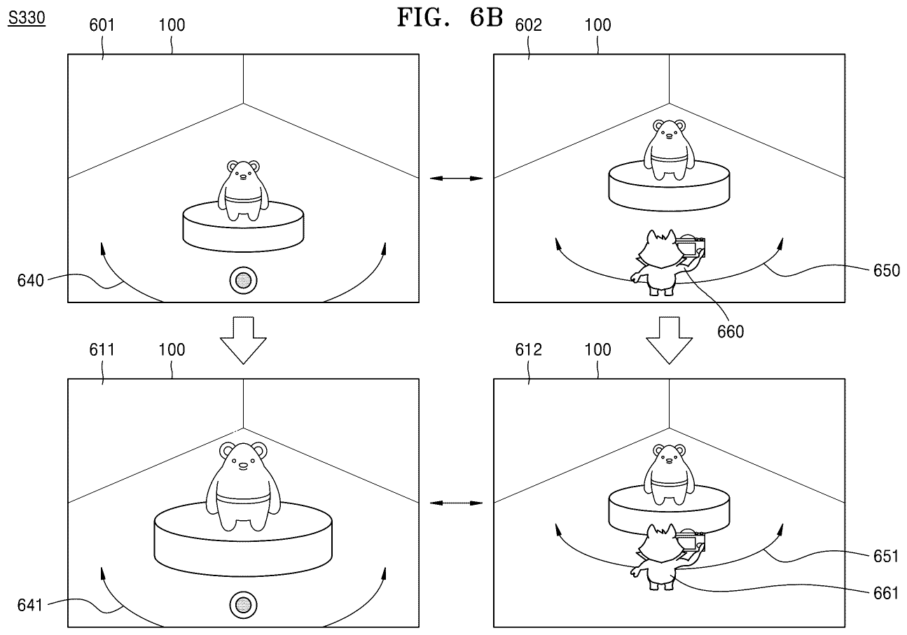

Subsequently, the electronic device 100 may generate a customized pattern according to the user's setting, which will be described in detail in connection with FIGS. 6 to 9.

FIGS. 6A and 6B illustrate operations of an electronic device for controlling the location of a pattern in a pattern providing service, according to an embodiment. Operations shown in FIG. 6A may be included in operation S330 of FIG. 3. Referring to FIG. 6B, the electronic device 100 may display a first-person virtual space screen 601 and a third-person virtual space screen 602. In an embodiment, an avatar 660 to capture a target object may not appear on the first-person virtual space screen 601, and the avatar 660 may appear on the third-person virtual space screen 602.

In an embodiment, the electronic device 100 may display a pattern 640 based on the gaze of an avatar 660 on the first-person virtual space screen 601. For example, the electronic device 100 may display a pattern 650 based on the location of the avatar 660 on the third-person virtual space screen 602.

In operation S605, the electronic device 100 may receive an input to change the location of the avatar included in the virtual space. In operation S615, the electronic device 100 may control the position of the pattern.

For example, based on the input to control the state of the pattern, the electronic device 100 may display customized patterns 641 and 651 on the first-person virtual space screen 611 and the third-person virtual space screen 612. In an embodiment, an avatar 661 to capture a target object may not appear on the first-person virtual space screen 611, and the avatar 661 may appear on the third-person virtual space screen 612.

For example, the electronic device 100 may change the location of the pattern 641 or 651 based on the input to change the location of the avatar 661. For example, the electronic device 100 may move the location of the pattern 641 or 651 upward, downward, to the left or to the right, based on an input to move the avatar 661 upward, downward, to the left or to the right.

For example, the electronic device 100 may receive an input to change the location so that the avatar 661 comes closer to the target object. Based on the input, the electronic device 100 may change the location of the pattern 641 or 651 so that the pattern 641 or 651 comes closer to the target object.

For example, the electronic device 100 may display the pattern 641 that comes closer to the target object based on the gaze of the avatar 661 on the first-person virtual space screen 611. For example, the electronic device 100 may display the pattern 651 that comes closer to the target object based on the location of the avatar 661 on the third-person virtual space screen 612.

Subsequently, in operation S340, the electronic device 100 may control the avatar to capture the virtual space while moving along the customized pattern 641 or 651.

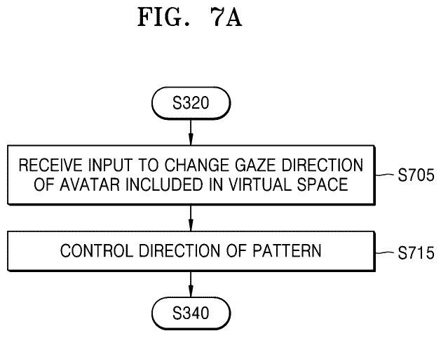

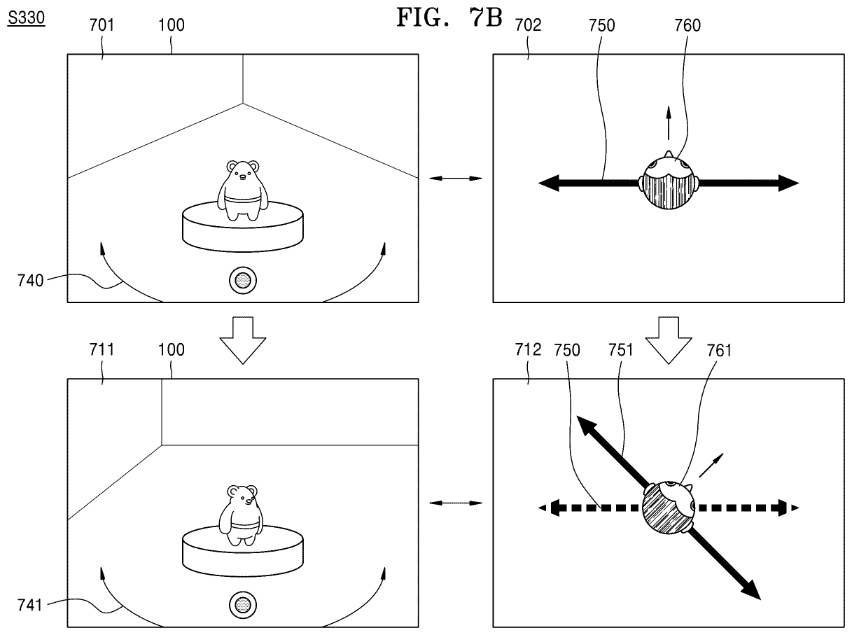

FIGS. 7A and 7B illustrate operations of an electronic device for controlling a direction of a pattern in a pattern providing service, according to an embodiment. Operations shown in FIG. 7A may be included in operation S330 of FIG. 3.

Referring to FIG. 7B, the electronic device 100 may display a first-person virtual space screen 701 and a third-person virtual space screen 702. In an embodiment, an avatar 760 to capture a target object may not appear on the first-person virtual space screen 701, and the avatar 760 may appear on the third-person virtual space screen 702. For convenience of explanation, no target object is shown on the third-person virtual space screen 702.

In an embodiment, the electronic device 100 may display a pattern 740 based on the gaze of an avatar 760 on the first-person virtual space screen 701. For example, the electronic device 100 may display a pattern 750 based on the location of the avatar 760 on the third-person virtual space screen 702.

In operation S705, the electronic device 100 may receive an input to change the gaze direction of an avatar included in the virtual space. In operation S715, the electronic device 100 may control the direction of the pattern.

For example, based on the input to control the state of the pattern, the electronic device 100 may display customized patterns 741 and 751 on a first-person virtual space screen 711 and a third-person virtual space screen 712, respectively. An avatar 761 to capture a target object may not appear on the first-person virtual space screen 711, and the avatar 761 may appear on the third-person virtual space screen 712.

For example, the electronic device 100 may change the direction of the pattern 741 or 751 based on the input to change the gaze direction of the avatar 761. For example, the electronic device 100 may change the extension direction of the pattern 641 or 651 to an X-axis direction, Y-axis direction or diagonal direction based on an input to move the gaze direction of the avatar 761 forward, to the right or to the left.

For example, the electronic device 100 may receive an input to change the gaze direction of the avatar 761 from front to right. The avatar 761 may change the gaze from front to right. Based on the input, the electronic device 100 may change the pattern 740 or 750 extending in the X-axis direction to the pattern 741 or 751 extending in the diagonal direction.

For example, the electronic device 100 may display the pattern 741 that looks to the left of the target object based on the gaze of the avatar 761 on the first-person virtual space screen 711. For example, the electronic device 100 may display the pattern 751 that looks to the left of the target object and extends in the diagonal direction, based on the location of the avatar 761 on the third-person virtual space screen 712.

Subsequently, in operation S340, the electronic device 100 may control the avatar to capture the virtual space while moving along the customized pattern 741 or 751.

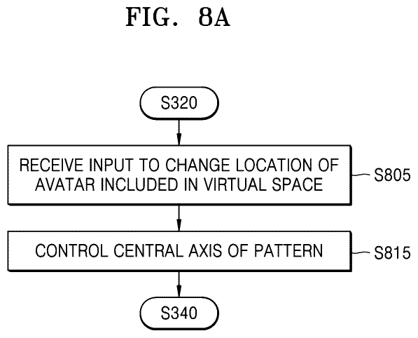

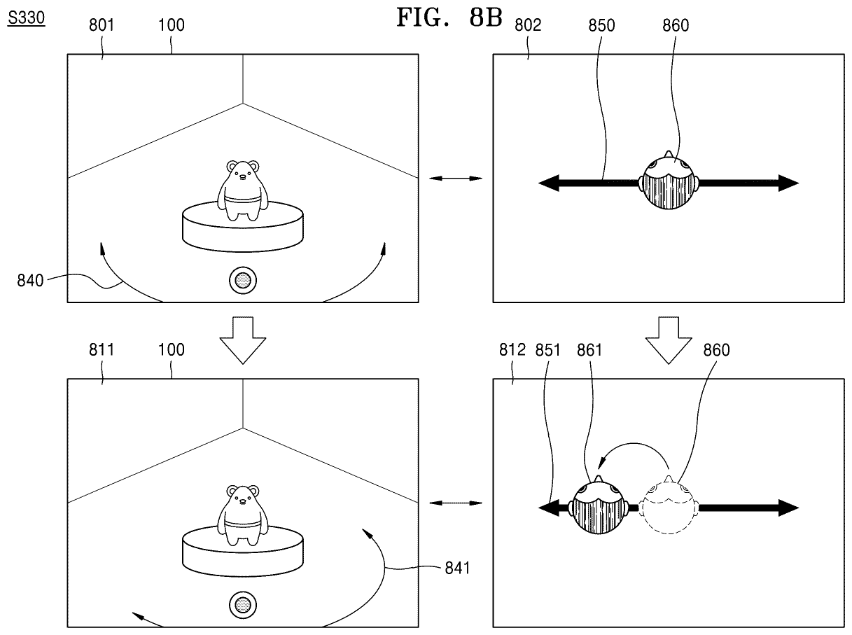

FIGS. 8A and 8B illustrate operations of an electronic device for controlling the central axis of a pattern in a pattern providing service, according to an embodiment. Operations shown in FIG. 8A may be included in operation S330 of FIG. 3.

Referring to FIG. 8B, the electronic device 100 may display a first-person virtual space screen 801 and a third-person virtual space screen 802. An avatar 860 to capture a target object may not appear on the first-person virtual space screen 801, and the avatar 860 may appear on the third-person virtual space screen 802. For convenience of explanation, no target object is shown on the third-person virtual space screen 802.

In an embodiment, the electronic device 100 may display a pattern 840 based on the gaze of an avatar 860 on the first-person virtual space screen 801. For example, the electronic device 100 may display a pattern 850 based on the location of the avatar 860 on the third-person virtual space screen 802.

In operation S805, the electronic device 100 may receive an input to change the location of the avatar included in the virtual space. In operation S815, the electronic device 100 may control the central axis of the pattern.

For example, based on the input to control the state of the pattern, the electronic device 100 may display customized patterns 841 and 851 on a first-person virtual space screen 811 and a third-person virtual space screen 812, respectively. An avatar 861 may not appear on the first-person virtual space screen 811, and the avatar 861 may appear on the third-person virtual space screen 812.

For example, the electronic device 100 may change the central axis of the pattern 841 or 851 based on the input to change the location of the avatar 861. For example, the electronic device 100 may move the central axis of the pattern 841 or 851 upward, downward, to the left or to the right, based on an input to move the avatar 861 upward, downward, to the left or to the right.

For example, the electronic device 100 may receive an input to change the location so that the avatar 861 moves to the left of the pattern extending in the X-axis. Based on the input, the electronic device 100 may change the central axis of the pattern 841 or 851 so that the central axis of the pattern 841 or 851 moves from the center to the left.

For example, the electronic device 100 may change the central axis of the pattern 841 to be moved to the left based on the avatar 861 on the first-person virtual space screen 811. The electronic device 100 may display the first-person virtual space screen 811 on which the central axis of the pattern 841 is moved to the left. For example, the electronic device 100 may change the central axis of the pattern 851 to be moved to the left based on the avatar 861 on the third-person virtual space screen 812. The electronic device 100 may display the third-person virtual space screen 812 on which the central axis of the pattern 851 is moved to the left.

In an embodiment, based on an input to change the location of the avatar, the electronic device 100 may change the location of the pattern as shown in FIG. 6 or change the central axis of the pattern as shown in FIG. 8.

Subsequently, in operation S340, the electronic device 100 may control the avatar to capture the virtual space while moving along the customized pattern 841 or 851.

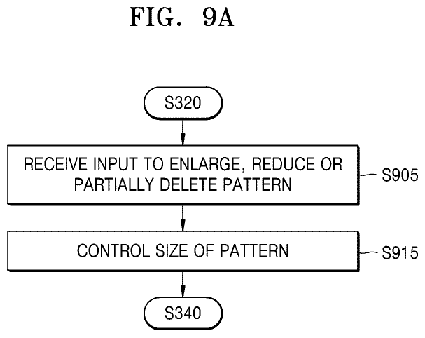

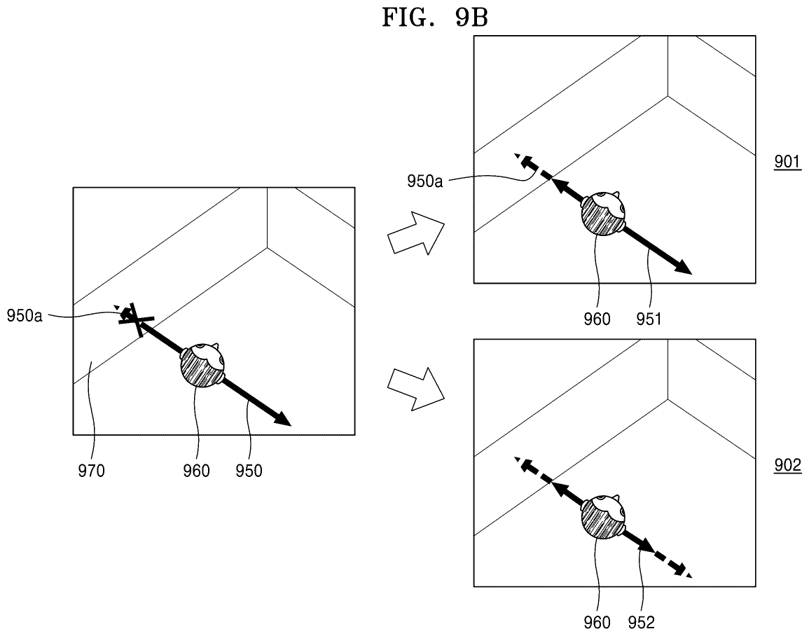

FIGS. 9A and 9B illustrate operations of an electronic device for controlling the size of a pattern in a pattern providing service, according to an embodiment. Operations shown in FIG. 9A may be included in operation S330 of FIG. 3.

Referring to FIG. 9B, the electronic device 100 may display a third-person virtual space screen that includes an avatar 960.

In operation S905, the electronic device 100 may receive an input to enlarge, reduce or partially delete the pattern. In operation S915, the electronic device 100 may control the size of the pattern.

For example, as the pattern 950 is displayed in a virtual space based on the current location of the avatar 960, the pattern 950 may overlap an obstacle 970 or deviate from a certain space. The obstacle 970 is illustrated as a wall that is present in the virtual space. The electronic device 100 may identify a portion 950a in which the pattern 950 and the obstacle 970 overlap. The electronic device 100 may highlight the portion 950a of the pattern 950 that overlaps the obstacle 970. For example, the electronic device 100 may display the portion 950a of the pattern 950 with X marks, in a different color, or in a dotted line.

The user may delete part of the pattern 950 where the obstacle 970 and the movement line overlap, or reduce/enlarge the overall size of the pattern. The electronic device 100 may control the size of the pattern based on an input to enlarge or reduce or partially delete the pattern.

For example, in a first situation 901, the electronic device 100 may control a portion of a pattern 951 to be deleted based on an input to delete the portion of the pattern 951.

For example, in a second situation 902, the electronic device 100 may control the overall size of a pattern 952 to be reduced based on an input to reduce the size of the pattern 952.

For example, in a third situation, the electronic device 100 may control the overall size of the pattern to be enlarged based on an input to enlarge the size of the pattern.

In an embodiment, even without any user input, when the pattern 950 overlaps the obstacle 970 that is present in the virtual space, the electronic device 100 may control the portion 950a where the pattern 950 overlaps the obstacle 970 to be deleted.

Subsequently, in operation S340, the electronic device 100 may control the avatar to capture the virtual space while moving along the customized pattern 951 or 952.

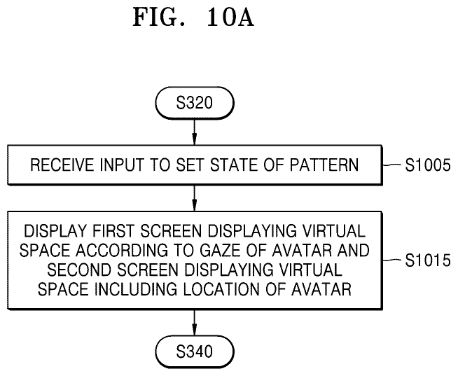

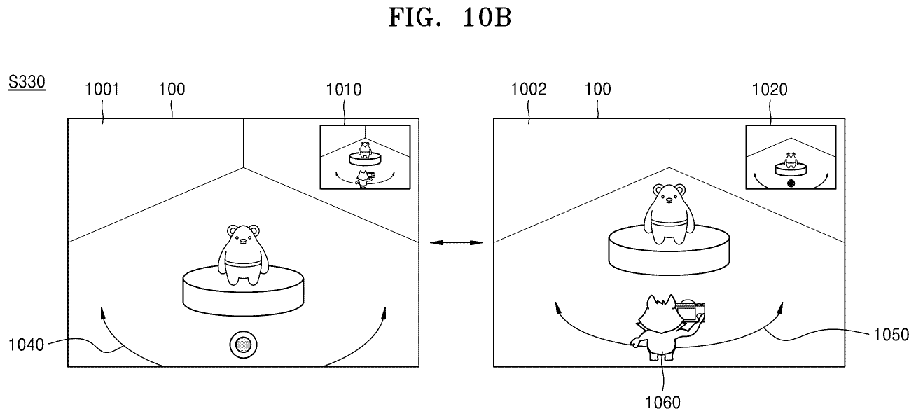

FIGS. 10A and 10B illustrate operations of an electronic device for displaying a customized pattern and a preview screen, according to an embodiment. Operations shown in FIG. 10A may be included in operation S330 of FIG. 3.

Referring to FIG. 10B, the electronic device 100 may display a first-person virtual space screen 1001 and a third-person virtual space screen 1002. An avatar 1060 may not appear on the first-person virtual space screen 1001, and the avatar 1060 may appear on the third-person virtual space screen 1002. The electronic device 100 may display a customized pattern 1040 or 1050.

In an embodiment, the electronic device 100 may generate the customized pattern 1040 or 1050 and an image capturing movement line of the avatar 1060 according to the customized pattern 1040 or 1050 in a preview screen 1010 or 1020 before image capturing so as for the user to intuitively set the customized pattern 1040 or 1050. The preview screen 1010 or 1020 may be generated based on an input to set a state of the pattern.

In operation S1005, the electronic device 100 may receive the input to set a state of the pattern. In operation S1015, the electronic device 100 may display a first screen that displays a virtual space according to the gaze of the avatar 1060 and a second screen that displays a virtual space including the location of the avatar 1060. For example, the electronic device 100 may display a first-person screen that displays a virtual space according to the gaze of the avatar 1060 and a third-person screen that displays a virtual space including the location of the avatar 1060.

In an embodiment, the electronic device 100 may display the first-person virtual space screen 1001 as a full screen and display the third-person virtual space screen 1002 as a preview screen 1010.

For example, the electronic device 100 may display the first-person virtual space screen 1001 as a full screen. In this case, as the user is unable to check the overall state of the pattern when the user is setting a state of the pattern 1040 on the first-person virtual space screen 1001, the user has difficulty in predicting a capturing movement of the avatar 1060. In an embodiment, the electronic device 100 may display the third-person preview screen 1010 for the user to intuitively predict the capturing movement. The user may check the overall direction and size of the pattern, the location of the avatar 1060, etc., through the third-person preview screen 1010.

In an embodiment, the preview screen 1010 is illustrated as being arranged at the upper right corner in one fourth the size, but the disclosure is not limited to the above example embodiment. For example, the preview screen 1010 may be enlarged or reduced by the user, or moved by the user.

In an embodiment, the electronic device 100 may display the third-person virtual space screen 1002 as a full screen and display the first-person virtual space screen 1001 as a preview screen 1020. For example, the electronic device 100 may display the first-person preview screen 1020 to predict the captured screen according to the capturing movement.

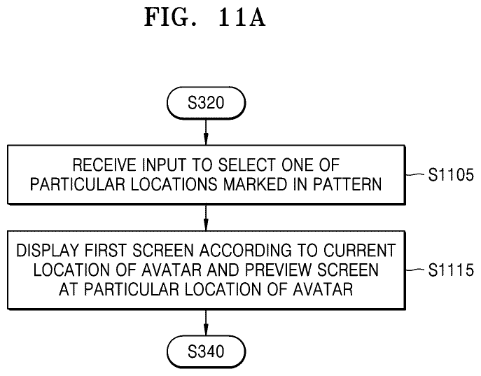

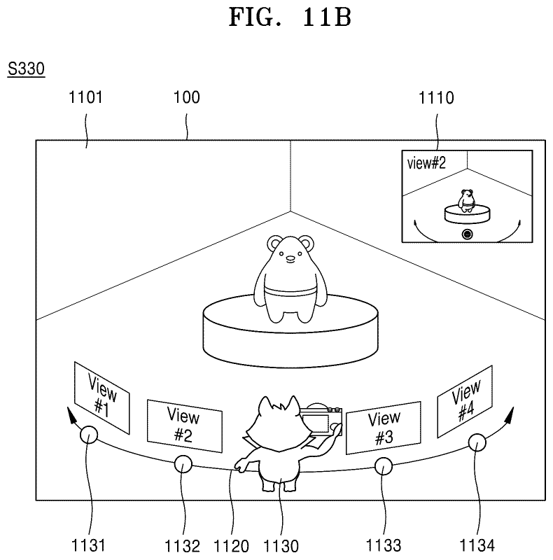

FIGS. 11A and 11B illustrate operations of an electronic device for displaying a customized pattern and a preview screen, according to an embodiment. Operations shown in FIG. 11A may be included in operation S330 of FIG. 3.

Referring to FIG. 11B, the electronic device 100 may display a third-person virtual space screen 1101. An avatar 1130 may appear on the third-person virtual space screen 1101. The electronic device 100 may display a customized pattern 1120.

In an embodiment, the electronic device 100 may display a screen to be captured when the avatar 1130 is positioned at a certain location on the customized pattern 1120 as a preview screen 1110 in order for the user to predict the screen to be captured according to the customized pattern 1120.

In operation S1105, the electronic device 100 may receive an input to select one of particular locations 1131, 1132, 1133 and 1134 marked in the pattern 1120.

For example, the electronic device 100 may display the pattern 1120 and the particular locations 1131, 1132, 1133 and 1134 marked in the pattern 1120. For example, the particular location 1131 indicates a screen to be captured in a first view, view #1; the particular location 1132 indicates a screen to be captured in a second view, view #2; the particular location 1133 indicates a screen to be captured in a third view, view #3; the particular location 1134 indicates a screen to be captured in a fourth view, view #4. In one embodiment, four of the particular locations 1131, 1132, 1133 and 1134 are illustrated. However, the disclosure is not limited to the above example embodiment. For example, the pattern 1120 may include less than or more than four points.

For example, the user may select one of the particular locations 1131, 1132, 1133 and 1134 to check in advance screens to be captured at the particular locations 1131, 1132, 1133 and 1134 marked in the pattern 1120. The electronic device 100 may receive a user input to select one of the particular locations 1131, 1132, 1133 and 1134.

In operation S1115, the electronic device 100 may display a first screen 1101 according to the current location of the avatar 1130 and the preview screen 1110 at a particular location of the avatar 1130. For example, the preview screen 1110 may be arranged at an upper right corner in one fourth the size, enlarged/reduced or moved by the user.

For example, the electronic device 100 may display the first screen 1101 in a full area and display the preview screen 1110 at the particular location in a partial area.

For example, the electronic device 100 may display the preview screen 1110 in the second view, view #2, based on receiving of a user input to select the particular location 1132. For example, the particular location 1132 is on the left of the pattern 1120, so the avatar 1130 in the particular location 1132 may look at the object to be captured from the left. The preview screen 1110 may be a screen to be captured according to the gaze direction of the avatar 1130 to an object to be captured at the particular location 1132.

The user may predict a screen to be captured according to the gaze direction of the avatar along the customized pattern through the preview screen 1110 before image capturing.

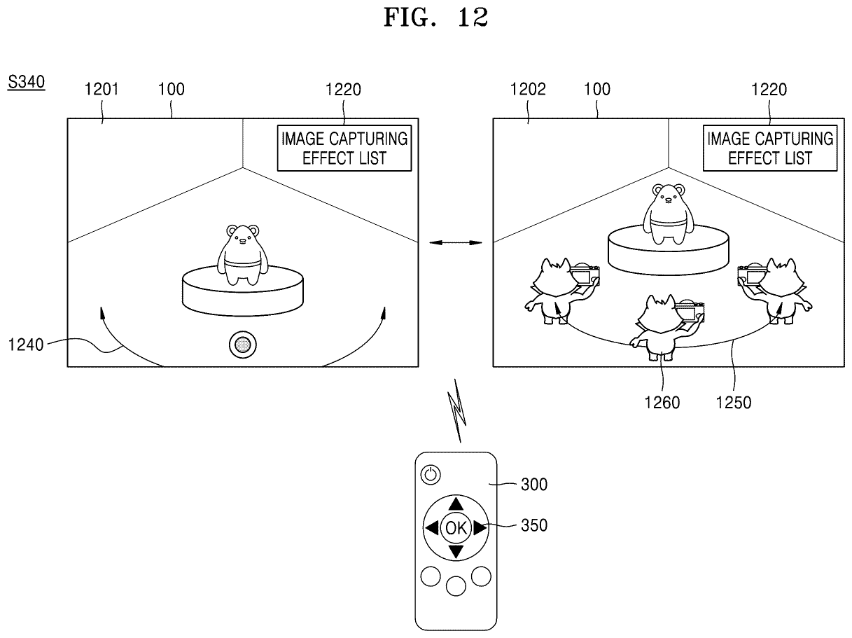

FIG. 12 illustrates operations of an electronic device for capturing an image of a virtual space according to a customized pattern in a pattern providing service, according to an embodiment. Operations shown in FIG. 12 may correspond to operation S340 of FIG. 3.

Referring to FIG. 12, the electronic device 100 may display a first-person virtual space screen 1201 and a third-person virtual space screen 1202. An avatar 1260 may not appear on the first-person virtual space screen 1201, and the avatar 1260 may appear on the third-person virtual space screen 1202. The electronic device 100 may display a customized pattern 1240 or 1250.

In an embodiment, the electronic device 100 may control the avatar 1260 to move along the pattern 1240 or 1250 based on an input to control the movement direction of the avatar.

In an embodiment, the electronic device 100 may communicate with a control device 300 over a communication network. The control device 300 may include direction keys 350, e.g., a right key, a left key, an up key and a down key. The user may control the movement direction of the avatar to the right, to the left, upward and downward based on an input to select the direction key 350 of the control device 300. The electronic device 100 may usually control the avatar 1260 to move in at least one direction among to the right, to the left, upward and downward, based on the user selecting one direction from among to the right, to the left, upward and downward of the direction key 350.

In an embodiment, the electronic device 100 may control the avatar 1260 to move along the pattern 1240 or 1250 without deviating from the pattern 1240 or 1250 based on an input to control the movement direction of the avatar 1260. In the present disclosure, the pattern 1240 or 1250 is illustrated as a moving pattern extending to the left and right. For example, the electronic device 100 may control the avatar to move to the left or right along the pattern 1240 or 1250 in response to a user input selecting a left or right direction. For example, the electronic device 100 may control the avatar 1260 to not move based on a user input selecting an upward or downward direction. In an embodiment, for example, the electronic device 100 may control the avatar 1260 to move to the left in response to a user input selecting the upward direction and to the right in response to a user input selecting the downward direction.

In an embodiment, based on an input to set an image capturing effect, the electronic device 100 may control image capturing according to the image capturing effect. For example, the electronic device 100 may display an image capturing effect list 1220 in a partial area. The image capturing effect list 1220 may include various image capturing effects, including, for example, flashing, movement speed adjustment, lighting, camera swaying, exposure, zoom-in/zoom-out, etc.

The user may select an image capturing effect to be processed for the captured image. In an embodiment, the electronic device 100 may receive a user input to select an image capturing effect through the input interface 140. For example, the electronic device 100 may receive a user input to select a flash effect, and control the flash effect to be processed for the captured image based on the user input.

In an embodiment, the electronic device 100 may capture the virtual space based on the avatar 1260 that is moving along the pattern 1240 or 1250. For example, the electronic device 100 may store screen information of a virtual space located in a direction toward which the avatar 1260 gazes. For example, the electronic device 100 may store the screen information of the virtual space and generate the captured screen or captured image.

A method by which the electronic device 100 and the server 200 share a captured screen in which a virtual space is captured according to a captured screen sharing service will now be described according to an embodiment of the present disclosure.

FIG. 13 illustrates an operating method between a server and a plurality of electronic devices for providing a captured screen sharing service, according to an embodiment.

Referring to FIG. 13, the first electronic device 101 may invite the second electronic device 102 to share a captured screen through the server 200. An avatar corresponding to the user of the first electronic device 101 may be a first avatar. An avatar corresponding to the user of the second electronic device 102 may be a second avatar. In the present disclosure, the first avatar may captures (an object in) a virtual space and shares the captured screen (about the object or the virtual space). The second avatar may be a target avatar for sharing to receive a screen captured by the first avatar. The first avatar may share a screen, on which the second avatar is captured as a target object, with the second avatar, and share a screen, on which another target object is captured, with the second avatar.

In operation S1305, the first electronic device 101 according to an embodiment may receive an input to select a sharing target with which the captured screen is to be shared. For example, the first electronic device 101 may receive an input to select the second avatar as a sharing target, with which a screen captured by the first avatar is to be shared. In an embodiment, the sharing target may be located in the same space with the first avatar in the virtual space, and located near the first avatar. In other words, the sharing target may be located near the first avatar within the view of the first avatar. In an embodiment, the first electronic device 101 may display the sharing target on the first-person virtual space screen.

In an embodiment, the first electronic device 101 may display a user interface to invite the sharing target to the captured screen sharing service, and invite the sharing target to the captured screen sharing service in response to an input to the user interface.

In operation S1310, the first electronic device 101 according to an embodiment may transmit a request signal to invite the sharing target to the server 200. For example, the first electronic device 101 may request the server 200 to invite the second electronic device 102 that uses the second avatar to the captured screen sharing service. For example, the first electronic device 101 may transmit a request signal to invite the second avatar to the server 200.

In operation S1315, the server 200 in an embodiment may identify an invitation code based on the request signal. For example, the server 200 may generate the invitation code that includes information about the sharing target, a sharing host, and the captured screen sharing service, and identify who the sharing target is, who the host for sharing is, and what the service is by identifying the invitation code. For example, when the first avatar of the first electronic device 101 invites the second avatar of the second electronic device 102, the server 200 may combine an ID of the first avatar and an ID of the second avatar to generate the invitation code like “first avatar-to-second avatar”. In an embodiment, for example, the server 200 may identify the sharing target, the sharing host, etc., with the IDs of the first and second avatars even without the invitation code.

For example, by identifying the invitation code, the server 200 may identify that the sharing host is the first electronic device 101, the sharing target is the second electronic device 102, and the captured screen sharing service is to be provided to the first electronic device 101 and the second electronic device 102.

In operation S1320, the server 200 according to an embodiment may transmit the invitation code to the sharing target. For example, the server 200 may transmit the invitation code to the second electronic device 102 as the sharing target based on the information about the sharing target, the sharing host and the captured screen sharing service identified through the invitation code.

In operation S1325, the second electronic device 102 according to an embodiment may provide a user interface for inquiring whether to agree to sharing the captured screen. For example, the second electronic device 102 may provide the user interface for inquiring whether to access the captured screen sharing service based on receiving of the invitation code from the server 200.

In operation S1330, the second electronic device 102 according to an embodiment may receive an input to agree to sharing the captured screen. For example, the user may agree to sharing the captured screen through the user interface displayed on the second electronic device 102.

In operation S1335, the second electronic device 102 according to an embodiment may transmit an input signal to agree to sharing the captured screen to the server 200. For example, the input signal may include information indicating that the second electronic device 102 accepts the invitation to the captured screen sharing service.

In operation S1340, the server 200 in an embodiment may identify the invitation code based on the input signal. For example, the server 200 may identify information about the sharing target and information indicating acceptance of invitation to the captured screen sharing service through the invitation code. For example, the server 200 may identify the sharing host through the invitation code.

In operation S1345, the server 200 according to an embodiment may transmit the input signal to the first electronic device 101. For example, the server 200 may transmit a signal including the information indicating acceptance of the invitation to the captured screen sharing service to the first electronic device 101.

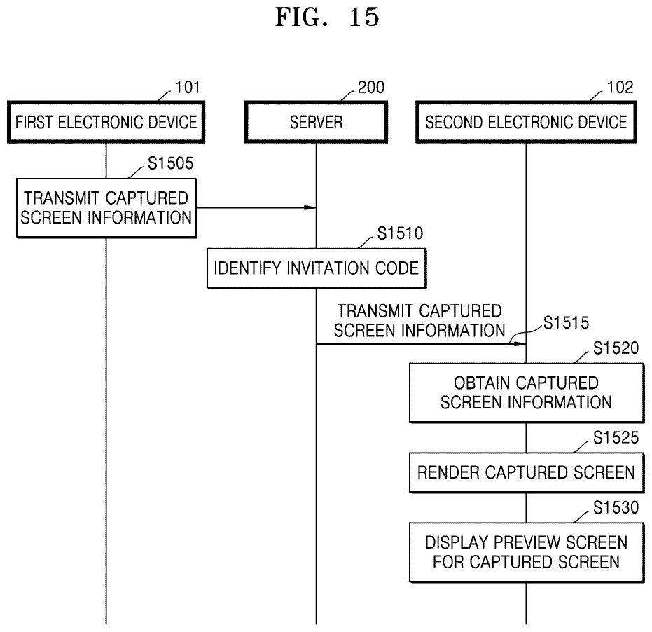

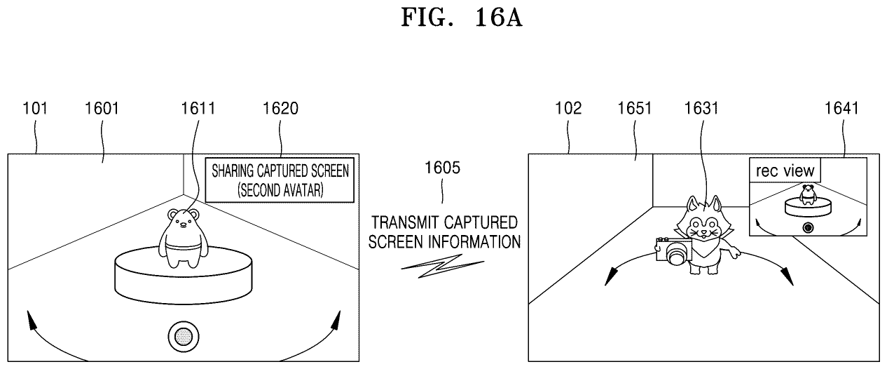

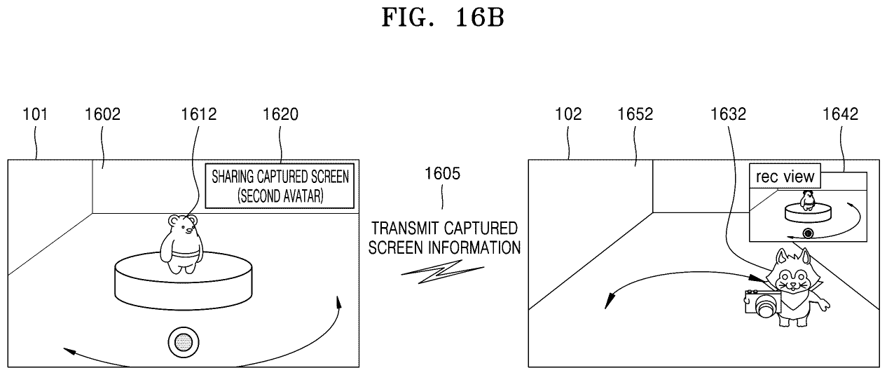

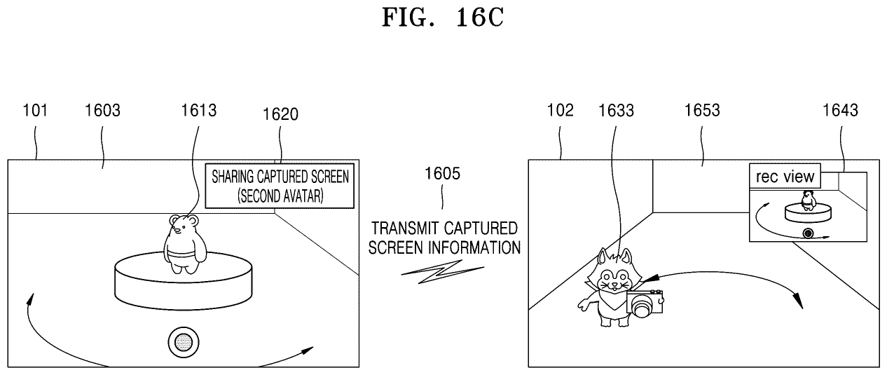

In operation S1350, the first electronic device 101 according to an embodiment may receive the input signal and share the captured screen based on the received input signal. For example, the first electronic device 101 may transmit captured screen information including position information and direction information of the first avatar. In this case, on receiving the captured screen information, the second electronic device 102 may render the captured screen based on the position information and direction information of the first avatar. In an embodiment, for example, the first electronic device 101 may transmit a captured screen or captured image in the view of the first avatar. This will be described in detail in connection with FIGS. 15 and 16.

In an embodiment, the first electronic device 101 may provide a user interface notifying a sharing progress and a sharing target of the captured screen while sharing the captured screen.

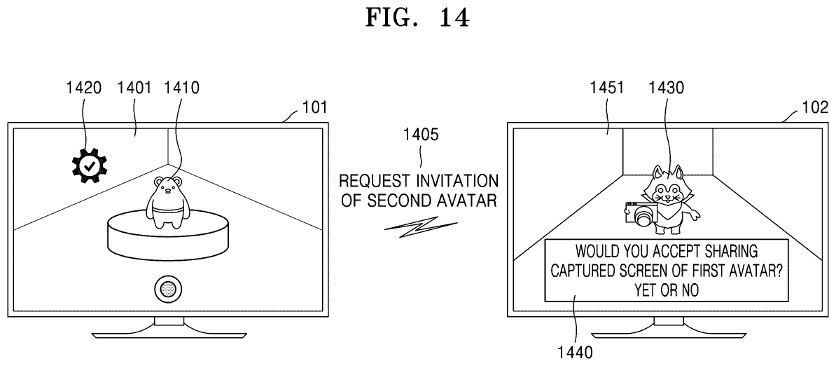

FIG. 14 illustrates operations of a plurality of electronic devices that share a captured screen, according to an embodiment.

Referring to FIG. 14, the first electronic device 101 may display a virtual space screen 1401 that looks at a second avatar 1410 according to the gaze of a first avatar, and display a virtual space screen 1451 that looks at the first avatar 1430 according to the gaze of the second avatar. In FIG. 14, illustrated is an occasion when the first avatar 1430 of the first electronic device 101 captures the second avatar 1410 and shares the captured screen with the second avatar 1410. In an embodiment, the first avatar 1430 may capture another object instead of the second avatar 1410 and share the captured screen with the second avatar 1410.

As the virtual space screen 1401 of the first electronic device 101 is a first-person virtual space screen, the first avatar 1430 of the first electronic device 101 may not appear. As the virtual space screen 1451 of the second electronic device 102 is a first-person virtual space screen, the second avatar 1410 of the second electronic device 102 may not appear.

In an embodiment, the first electronic device 101 may receive an input to select the second avatar 1410 for sharing the captured screen. The user may select the second avatar 1410 located close to the first avatar in the same space to share the captured screen with the second avatar 1410.

In an embodiment, the first electronic device 101 may display a sharing service UI 1420 at a location close to the second avatar 1410. The sharing service UI 1420 may be a UI that allows the sharing target to be invited to the captured screen sharing service. The sharing service UI 1420 may be displayed as a cogwheel icon, but the disclosure is not limited to the above example embodiment.

In an embodiment, the first electronic device 101 may receive a user input to select the sharing service UI 1420 adjacent to the second avatar 1410.

In an embodiment, the first electronic device 101 may invite the second avatar 1410 to the captured screen sharing service based on the user input to select the sharing service UI 1420. For example, the first electronic device 101 may send a request in 1405 to the second electronic device 102 for invitation of the second avatar 1410 through the server 200.

In an embodiment, the second electronic device 102 may display an inquiry UI 1440 for inquiring whether to agree to sharing the captured screen, based on an invitation code received through the server 200. The inquiry UI 1440 may include a message, for example, “would you accept sharing the captured screen of the first avatar? Yes or No”.

In an embodiment, based on receiving of an input “yes” on the inquiry UI 1440, the second electronic device 102 may generate an input signal to agree to sharing the captured screen. In an embodiment, based on receiving of an input “no” on the inquiry UI 1440, the second electronic device 102 may generate an input signal not to agree to sharing the captured screen.

In an embodiment, the second electronic device 102 may access the captured screen sharing service by transmitting the input signal to the server 200.

In an embodiment, the first electronic device 101 and the second electronic device 102 may access the captured screen sharing service through the server 200, and transmit or receive the captured screen or captured image to or from each other.

FIG. 15 illustrates an operating method between a server and a plurality of electronic devices that share captured screens in a captured screen sharing service, according to an embodiment.

Referring to FIG. 15, the first electronic device 101 may share a captured screen with the second electronic device 102 through the server 200. As described in connection with FIG. 13, the first electronic device 101 may invite the second electronic device 102 to the captured screen sharing service, and the second electronic device 102 may accept the invitation.

In operation S1505, the first electronic device 101 according to an embodiment may transmit captured screen information to the server 200. For example, the captured screen information may include information about a location of the first avatar, a gaze direction of the first avatar, a movement direction of the first avatar, etc. For example, the first electronic device 101 may transmit the location information, the gaze direction information, the movement direction information, etc., of the first avatar to the server 200.

In an embodiment, the first electronic device 101 may not compress the captured image generated according to the gaze of the first avatar for transmission to the server 200 but transmit only the captured screen information to the server 200. Accordingly, rendering in the first electronic device 101 is omitted, thereby minimizing the amount of computation.

In an embodiment, the first electronic device 101 may provide a user interface that notifies a sharing progress and a sharing target of the captured screen while sharing the captured screen information.

In operation S1510, the server 200 according to an embodiment may receive the captured screen information from the first electronic device 101, and identify the invitation code. For example, the server 200 may identify, through the invitation code, the sharing target, the sharing host and the captured screen sharing service. For example, the server 200 may transmit the captured screen information of the first electronic device 101 to the second electronic device 102 through the invitation code.

In operation S1515, the server 200 according to an embodiment may transmit the captured screen information to the second electronic device 102.

In operation S1520, the second electronic device 102 according to an embodiment may obtain the captured screen information.

In operation S1525, the second electronic device 102 according to an embodiment may render the captured screen based on the captured screen information. For example, the second electronic device 102 may generate a 3D virtual space viewed from the eye of the first avatar as a 2D graphic screen based on the location information, gaze direction information and movement direction information of the first avatar.

In operation S1530, the second electronic device 102 according to an embodiment may display a preview screen for the rendered captured screen. For example, the preview screen may be displayed in a partial or full area of the second electronic device 102.

In an embodiment, unlike the aforementioned example, when the first electronic device 101 transmits the rendered captured image to the server 200, the second electronic device 102 may receive the captured image from the server 200.

FIGS. 16A, 16B and 16C illustrate operations of a plurality of electronic devices that share a captured screen, according to an embodiment.

Referring to FIG. 16A, the first electronic device 101 may display a virtual space screen 1601 that looks at the second avatar 1611 according to the gaze of the first avatar. The second electronic device 102 may display a virtual space screen 1631 that looks at the first avatar 1631 according to the gaze of the second avatar. In FIGS. 16A, 16B and 16C, illustrated is an occasion when the first avatar 1631 of the first electronic device 101 captures the second avatar 1611 as a target object to be captured and shares the captured screen with the second avatar 1611.

As the virtual space screen 1601 of the first electronic device 101 is a first-person virtual space screen, the first avatar 1630 of the first electronic device 101 may not appear. As the virtual space screen 1651 of the second electronic device 102 is a first-person virtual space screen, the second avatar 1610 of the second electronic device 102 may not appear.

In an embodiment, the first electronic device 101 may transmit, in 1605, captured screen information to the second electronic device 102. The first electronic device 101 may provide a notification UI 1620 that notifies a sharing progress and a sharing target of the captured screen while sharing the captured screen information. For example, the notification UI 1620 may include a message “sharing the captured screen (second avatar)”.

For example, the first electronic device 101 may transmit location information, gaze direction information and movement direction information of the first avatar looking at the second avatar 1611 from the front.

In an embodiment, the second electronic device 102 may render the captured screen based on the captured screen information received from the first electronic device 101. For example, the second electronic device 102 may receive the location information, gaze direction information and movement direction information of the first avatar 163 looking at the second avatar 1611 from the front, and compute a distance to the first avatar 1631 from the second avatar 1611, a direction of the first avatar 1631 with respect to the second avatar 1611, etc. The second electronic device 102 may generate a 3D virtual space viewed from the eye of the first avatar 1631 in the virtual space on a 2D graphic screen. For example, the second electronic device 102 may generate an image of the second avatar 1611 captured from the front.

In an embodiment, the second electronic device 102 may display the rendered captured screen as a preview screen 1641. For example, the preview screen 1641 may include an image of the second avatar 1611 captured from the front.

In an embodiment, the preview screen 1641 is illustrated as being arranged at the upper right corner in one fourth the size. For example, the preview screen 1641 may be enlarged or reduced by the user, or moved by the user.

Referring to FIG. 16B, the first electronic device 101 may display a virtual space screen 1602 that looks at the second avatar 1612 according to the gaze of the first avatar. The second electronic device 102 may display a virtual space screen 1632 that looks at the first avatar 1632 according to the gaze of the second avatar. In FIG. 16B, the first avatar of the first electronic device 101 may look at the second avatar 1612 from the left. Accordingly, the left side of the second avatar 1612 may be displayed on the virtual space screen 1602 of the first electronic device 101, and the first avatar 1632 located on the right from the second avatar 1612 may be displayed on the virtual space screen 1652 of the second electronic device 102. This will now be described by focusing on a difference from FIG. 16A.

In FIG. 16B, the first electronic device 101 according to an embodiment may transmit captured screen information, e.g., location information, gaze direction information and movement direction information of the first avatar looking at the second avatar 1612 from the left. In an embodiment, the second electronic device 102 may render the captured screen based on the captured screen information received from the first electronic device 101 and display the captured screen as a preview screen 1642. For example, the second electronic device 102 may generate an image of the second avatar 1612 captured from the left, and display the image of the second avatar 1612 as the preview screen 1642.

Referring to FIG. 16C, the first electronic device 101 may display a virtual space screen 1603 that looks at the second avatar 1613 according to the gaze of the first avatar. The second electronic device 103 may display a virtual space screen 1633 that looks at the first avatar 1633 according to the gaze of the second avatar. In FIG. 16C, the first avatar of the first electronic device 101 may look at the second avatar 1613 from the right. Accordingly, the right side of the second avatar 1613 may be displayed on the virtual space screen 1603 of the first electronic device 101, and the first avatar 1633 located on the left from the second avatar 1613 may be displayed on the virtual space screen 1653 of the second electronic device 103. This will now be described by focusing on a difference from FIG. 16A.

In FIG. 16C, the first electronic device 101 according to an embodiment may transmit captured screen information, e.g., location information, gaze direction information and movement direction information of the first avatar looking at the second avatar 1613 from the right. In an embodiment, the second electronic device 103 may render the captured screen based on the captured screen information received from the first electronic device 101 and display the captured screen as a preview screen 1643. For example, the second electronic device 103 may generate an image of the second avatar 1613 captured from the right, and display the image of the second avatar 1613 as the preview screen 1643.

FIG. 17 illustrates an operating method of an electronic device for providing a pattern providing service and a captured screen sharing service, according to an embodiment.

Referring to FIG. 17, in an embodiment, the plurality of electronic devices 101 and 102 may provide a pattern providing service and a captured screen sharing service. For example, the first electronic device 101 may capture an image according to a customized pattern through the pattern providing service, and share the captured screen with the second electronic device 102 through the captured screen sharing service. The pattern providing service was described in connection with FIGS. 3 to 12, and the captured screen sharing service was described in connection with FIGS. 13 to 16, so detailed descriptions thereof will not be repeated.

In operation S1710, the first electronic device 101 according to an embodiment may receive an input to select a sharing target for sharing the captured screen. Operation S1710 may correspond to operation S1305 of FIG. 13.

In operation S1720, the first electronic device 101 according to an embodiment may transmit a signal to request invitation of the sharing target. Operation S1720 may correspond to operation S1310 of FIG. 13.

In operation S1730, the first electronic device 101 according to an embodiment may receive an input to agree to sharing the captured screen. Operation S1720 may correspond to operation S1350 of FIG. 13.

In operation S1740, the first electronic device 101 according to an embodiment may receive an input to select a pattern from a list of patterns for camera moving. Operation S1740 may correspond to operation S310 of FIG. 3.

In operation S1750, the first electronic device 101 according to an embodiment may display the selected pattern based on the first avatar in the virtual space. Operation S1750 may correspond to operation S320 of FIG. 3.

In operation S1760, the first electronic device 101 according to an embodiment may generate a customized pattern based on an input to set a state of the pattern. Operation S1760 may correspond to operation S330 of FIG. 3.

In operation S1770, the first electronic device 101 according to an embodiment may transmit captured screen information of the first avatar that is moving along the customized pattern. Operation S1770 corresponds to operation S1505 of FIG. 15, and the captured screen information may include the location of the first avatar moving along the customized pattern, the gaze direction of the first avatar and the movement direction of the first avatar.

FIG. 18 illustrates a configuration of an electronic device, according to an embodiment.

An electronic device 1800 of FIG. 18 may be an example of or may correspond to the electronic device 100 of FIG. 2. Descriptions overlapping what are described in FIG. 2 will not be repeated.

Referring to FIG. 18, the electronic device 1800 may include a processor 1801 and a memory 1850. The processor 1801 and the memory 1850 included in the electronic device 1800 may perform the same operation as the processor 110 and the memory 150 included in the electronic device 100 of FIG. 2.

In an embodiment, the electronic device 1800 may include a tuner 1810, a communication interface 1820, a detector 1830, an input/output unit 1840, a video processor 1895, a display 1860, an audio processor 1870, an audio output unit 1880 and an input interface 1890 in addition to the processor 1801 and the memory 1850. The communication interface 1820 may correspond to the communication interface 120 of FIG. 2. The display 1860 may correspond to the display 130 of FIG. 2. The input interface 1890 may correspond to the input interface 140 of FIG. 2.

The tuner 1810 may tune in to and select a frequency of a channel that the electronic device 1800 intends to receive among a lot of radio components through amplification, mixing, resonance of broadcast content received by wire or wirelessly. The content received through the tuner 1810 may be decoded to be divided into audio, video and/or additional information. The divided audio, video and/or additional information may be stored in the memory 1850 under the control of the processor 1801.

In an embodiment, the communication interface 1820 may connect the electronic device 1800 to a peripheral device or external device, a server, a mobile terminal, etc., under the control of the processor 1801. The communication interface 1820 may include at least one communication module that is able to perform wireless communication. The communication interface 1820 may include at least one of a wireless local area network (WLAN) module 1821, a Bluetooth module 1822 or a wired Ethernet 1823 corresponding to the performance and structure of the electronic device 1800.

The WLAN module 1821 may transmit or receive Wi-Fi signals to or from the peripheral device according to the Wi-Fi communication standard. The Bluetooth module 1822 may receive Bluetooth signals transmitted from the peripheral device according to the Bluetooth communication standard. The Bluetooth module 1822 may be a Bluetooth low energy (BLE) communication module and may receive BLE signals. The Bluetooth module 1822 may scan BLE signals constantly or temporarily to detect whether a BLE signal is received.

The detector 1830 may detect the user's voice, the user's image or the user's interaction, and may include a microphone, a camera, a photo receiver, and a sensing unit.

The input/output unit 1840 may receive video (e.g., moving image signals or still image signals), audio (e.g., voice signals or music signals) and additional information from the external device under the control of the processor 1801. The input/output unit 1840 may include one of a high-definition multimedia interface (HDMI) port, a component jack, a PC port and a USB port.

The video processor 1895 may process image data to be displayed on the display 1860, and perform various image processing operations such as decoding, rendering, scaling, noise filtering, frame rate conversion, resolution conversion, etc., on the image data.

The display 1860 may output content received from a broadcasting station, from an external device such as an external server or external storage medium or provided by an over-the-top (OTT) service provider or metaverse content provider on a screen.

The audio processor 1870 processes audio data. The audio processor 1870 may perform various processes such as decoding, amplification, noise filtering, etc., on the audio data.

The audio output unit 1880 may output an audio included in the content received through the tuner 1810, an audio input through the communication interface 1820 or the input/output unit 1840 or an audio stored in the memory 1850 under the control of the processor 1801. The audio output unit 1880 may include at least one of a speaker, a headphone or a Sony/Phillips digital interface (S/PDIF) output terminal.

The input interface 1890 may receive a user input to control the electronic device 1800. The input interface 1890 may include various types of user input devices including a touch panel for detecting a touch of the user, a button for receiving a push operation of the user, a wheel for receiving a turning manipulation of the user, a keyboard, a dome switch, a microphone for voice recognition, a motion detection sensor for sensing a motion, etc. But, the disclosure is not limited to the above example embodiment.

In an embodiment, the input interface 1890 may receive a user input to control an avatar displayed on the display 1860. For example, the input interface 1890 may receive an input regarding a movement direction of the avatar under the control of the processor 1801. For example, when the input interface 1890 includes a remote controller having a directional key, the processor 1801 may control the movement direction of the avatar through the directional key.

In an embodiment, the input interface 1890 may receive a user input to control a user interface for an image capturing service displayed on the display 1860.

In an embodiment, the memory 1850 may store the operation module 1851, the camera moving pattern module 1852, the movement line operation module 1853, the capturing effect module 1854, the captured screen sharing module 1855 and the captured image management module 1856.

In an embodiment, the processor 1801 may execute one or more instructions stored in each of the operation module 1851, the camera moving pattern module 1852, the movement line operation module 1853, the image capturing effect module 1854, the captured screen sharing module 1855 and the captured image management module 1856 to perform an operation according to the present disclosure.

In an embodiment, the processor 1801 may execute one or more instructions stored in the operation module 1851 to process the user input received through the input interface. The processor 1801 may execute the operation module 1851 to run a menu of the virtual space content or control the movement direction of the avatar.

For example, the processor 1801 may execute the operation module 1851 to process the user input to select a pattern for camera moving, a pattern location, a pattern direction, a pattern size and an image capturing effect.

For example, the processor 1801 may execute the operation module 1851 to process a user input to move the location of the avatar, the gaze of the avatar, etc.

For example, the processor 1801 may execute the operation module 1851 to process a user input to select an avatar to be invited for sharing the captured screen.

In an embodiment, the processor 1801 may execute one or more instructions stored in the camera moving pattern module 1852 to receive a list of patterns for camera moving and synchronize the received list of patterns. In an embodiment, the processor 1801 may control the display to display the list of patterns.

In an embodiment, the processor 1801 may execute one or more instructions stored in the camera moving pattern module 1852 to control a state of the pattern and generate the customized pattern. For example, the state of the pattern may include the location of the pattern, the direction of the pattern, the central axis of the pattern and the size of the pattern.

In an embodiment, the processor 1801 may execute one or more instructions stored in the camera moving pattern module 1852 to generate a customized pattern that is customized for the user. For example, the customized pattern may have a location of the pattern, a direction of the pattern, a central axis of the pattern, a size of the pattern, etc., set to be customized for each user.

In an embodiment, the processor 1801 may execute one or more instructions stored in the camera moving pattern module 1852 to display a preview screen while setting the customized pattern. For example, when the full screen is the first-person screen, a third-person preview screen may be displayed. For example, when the full screen is the third-person screen, a first-person preview screen may be displayed.

In an embodiment, the processor 1801 may execute one or more instructions stored in the movement line operation module 1853 to control the avatar to move along the moving pattern through a user input to control the movement direction of the avatar. In other words, in an embodiment, the processor 1801 may control the avatar to move without deviating from the pattern based on an input to control the moving direction of the avatar.

In an embodiment, the processor 1801 may execute one or more instructions stored in the image capturing effect module 1854 to process an image capturing effect selected through a user input. For example, the image capturing effect may include one of flashing, moving speed adjustment, lighting, camera swaying, exposure, and zoom-in/zoom-out.

In an embodiment, the processor 1801 may execute one or more instructions stored in the captured screen sharing module 1855 to generate a user interface related to the captured screen sharing service. For example, the user interface may include a UI for providing the captured screen sharing service (or, a sharing service UI), an inquiry UI for inquiring whether to agree to sharing the captured screen, a notification UI for notifying the progress of sharing the captured screen, a preview screen of the captured screen, etc. In an embodiment, the processor 1801 may control the display 1860 to display the user interface.

In an embodiment, the processor 1801 may execute one or more instructions stored in the captured screen sharing module 1855 to forward the captured screen information to the server 200. For example, the captured screen information may include a location (or coordinates) of the first avatar corresponding to a camera, a gaze direction of the first avatar, a movement direction of the first avatar, etc. In this case, the processor 1801 may be included in the first electronic device 101 that includes the first avatar, which is a capturing avatar.

In an embodiment, the processor 1801 may execute one or more instructions stored in the captured screen sharing module 1855 to receive captured screen information from the server 200. In this case, the processor 1801 may be included in the second electronic device 102 that includes the second avatar, which is a sharing target. For example, the processor 1801 may render a captured screen based on the received captured screen information. For example, the processor 1801 may generate a 3D virtual space on a 2D screen based on the location (or coordinates) of the first avatar, the gaze direction of the avatar and the movement direction of the first avatar forwarded from the first electronic device 101. For example, the processor 1801 may control the generated 2D screen to be displayed.

In an embodiment, the processor 1801 may execute one or more instructions stored in a captured image management module 1856 to control the captured image to be stored, shared and deleted.

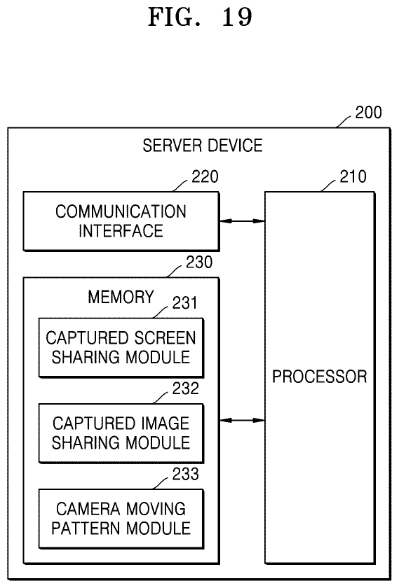

FIG. 19 illustrates a configuration of a server, according to an embodiment.

Referring to FIG. 19, the server 200 according to an embodiment may include a processor 210, a communication interface 220, and a memory 230.

In an embodiment, the communication interface 220 may transmit or receive data or a signal to or from the electronic device 100. For example, the communication interface 220 may include a Wi-Fi module, a Bluetooth module, an infrared communication module, a wireless communication module, a LAN module, an Ethernet module, a wired communication module, etc. In this case, each communication module may be implemented in the form of at least one hardware chip.

In an embodiment, the communication interface 220 may transmit the virtual space screen that includes an avatar to the electronic device 100 under the control of the processor 210. In an embodiment, the communication interface 220 may connect the electronic device 100 and the server 200 to a capturing service providing system under the control of the processor 210.

In an embodiment, the processor 210 may control general operations of the server 200 and signal flows between the internal components of the server 200, and process data.

In an embodiment, the processor 210 may include at least one of a central processing unit (CPU), a graphic processing unit (GPU) or a video processing unit (VPU). In an embodiment, the processor 210 may correspond to or may include a system on chip (SoC) that integrates at least one of the CPU, the GPU or the VPU. In an embodiment, the processor 210 may further include a neural processing unit (NPU).

In an embodiment, the memory 230 may store various data, programs, or applications for driving and controlling the server 200. The program stored in the memory 230 may include one or more instructions. The program (one or more instructions) or the application stored in the memory 230 may be executed by the processor 210.

In an embodiment, the memory 230 may store a captured screen sharing module 231, a captured image sharing module 232 and a camera moving pattern module 233.

In an embodiment, the processor 210 may execute one or more instructions stored in each of the captured screen sharing module 231, the captured image sharing module 232 and the camera moving pattern module 233.

In an embodiment, the processor 210 may execute one or more instructions stored in the captured screen sharing module 231 to receive captured screen information from the electronic device 100 that includes a sharing host. In an embodiment, the processor 210 may execute one or more instructions stored in the captured screen sharing module 231 to transmit captured screen information to the electronic device 100 including a sharing target. In an embodiment, the processor 210 may execute one or more instructions stored in the captured image sharing module 232 to receive a captured image from the electronic device 100 including the sharing host. In an embodiment, the processor 210 may execute one or more instructions stored in the captured image sharing module 232 to transmit a captured image to the electronic device 100 that includes a sharing target.

In an embodiment, the processor 210 may execute one or more instructions stored in the camera moving pattern module 233 to update the latest list of camera moving patterns and provide the list to the electronic device 100.

The machine-readable storage medium may be provided in the form of a non-transitory storage medium. The term ‘non-transitory storage medium’ may mean a tangible device without including a signal, e.g., electromagnetic waves, and may not distinguish between storing data in the storage medium semi-permanently and temporarily. For example, the non-transitory storage medium may include a buffer that temporarily stores data.

In an embodiment of the present disclosure, the aforementioned method according to the various embodiments of the present disclosure may be provided in a computer program product. The computer program product may be a commercial product that may be traded between a seller and a buyer. The computer program product may be distributed in the form of a machine-readable storage medium (e.g., a compact disc read only memory (CD-ROM)) or distributed directly between two user devices (e.g., smart phones) or online (e.g., downloaded or uploaded). In the case of the online distribution, at least part of the computer program product (e.g., a downloadable app) may be at least temporarily stored or arbitrarily created in a storage medium that may be readable to a device such as a server of the manufacturer, a server of the application store, or a relay server.

What is claimed is:

1. An electronic device for providing a virtual space, the electronic device comprising:
a display;
memory storing one or more instructions; and
at least one processor operatively connected to the display and the memory,
wherein the one or more instructions, which are executed by the at least one processor individually or collectively, cause the electronic device to:
receive a first input to select a pattern from a list of patterns for camera moving,
display the selected pattern with respect to a first avatar in the virtual space, and
capture an image of the virtual space based on the first avatar moving along the selected pattern.

2. The electronic device of claim 1, further comprising:
a communication interface,
wherein the one or more instructions, which are executed by the at least one processor individually or collectively, further cause the electronic device to:
receive the list of patterns that are set, in advance, from a server through the communication interface, and
control the display to display the list of patterns.

3. The electronic device of claim 1, wherein the one or more instructions, which are executed by the at least one processor individually or collectively, further cause the electronic device to:
display the selected pattern in the virtual space based on a location or gaze of the first avatar, and
perform the image capturing based on screen information about the gaze of the first avatar.

4. The electronic device of claim 1, wherein the one or more instructions, which are executed by the at least one processor individually or collectively, further cause the electronic device to generate a customized pattern based on a second input to set a state of the pattern, and
wherein the state of the pattern comprises one of a location of the pattern, a direction of the pattern, a central axis of the pattern, and a size of the pattern.

5. The electronic device of claim 1, wherein the one or more instructions, which are executed by the at least one processor individually or collectively, further cause the electronic device to:
perform one of controlling a location of the pattern based on an input to change a location of the first avatar in the virtual space,
controlling a direction of the pattern based on an input to change a gaze direction of the first avatar in the virtual space,
controlling a central axis of the pattern based on an input to change the location of the first avatar in the virtual space, and
controlling a size of the pattern based on an input to enlarge, reduce or partially delete the pattern.

6. The electronic device of claim 1, wherein the one or more instructions, which are executed by the at least one processor individually or collectively, further cause the electronic device to:
highlight a first portion of the pattern which overlaps an obstacle in the virtual space, and
control a second portion of the pattern to be deleted.

7. The electronic device of claim 1, wherein the one or more instructions, which are executed by the at least one processor individually or collectively, further cause the electronic device to control the display to display:
a first screen which displays a first virtual space based on a gaze of the first avatar, and
a second screen which displays a second virtual space including a location of the first avatar.

8. The electronic device of claim 1, wherein the one or more instructions, which are executed by the at least one processor individually or collectively, further cause the electronic device to control the first avatar to move without deviating from the pattern, based on an input to control a movement direction of the first avatar.

9. The electronic device of claim 1, wherein the one or more instructions, which are executed by the at least one processor individually or collectively, further cause the electronic device to process an image capturing effect, based on an input to set the image capturing effect, and
wherein the image capturing effect comprises one of flashing, moving speed adjustment, lighting, camera swaying, exposure, or zoom-in/zoom-out.

10. The electronic device of claim 1, further comprising:
a communication interface,
wherein the one or more instructions, which are executed by the at least one processor individually or collectively, further cause the electronic device to:
receive an input to select a second avatar for sharing a captured screen,
transmit, to a server through the communication interface, a request signal to invite the second avatar, and
based on receiving an input signal to agree to sharing a captured screen from the server through the communication interface, share the captured screen.

11. The electronic device of claim 1, wherein the one or more instructions, which are executed by the at least one processor individually or collectively, further cause the electronic device to execute the one or more instructions to transmit captured screen information to a server through a communication interface, and
wherein the captured screen information comprises one of a location of the first avatar, a gaze direction of the first avatar, a moving direction of the first avatar, and location information of the first avatar moving along the selected pattern.

12. A method of an electronic device for providing a virtual space, the method comprising:
receiving a first input to select a pattern from a list of patterns for camera moving;
displaying the selected pattern about a first avatar in the virtual space; and
capturing an image of the virtual space based on the first avatar moving along the selected pattern.

13. The method of claim 12, wherein the receiving of the first input to select the pattern from the list of patterns for camera moving, comprises:
receiving the list of patterns that are set, in advance, from a server through a communication interface, and
controlling a display to display the list of patterns.

14. The method of claim 12, further comprising:
displaying the selected pattern in the virtual space based on a location or gaze of the first avatar; and
performing the image capturing based on screen information about the gaze of the first avatar.

15. The method of claim 12, further comprising generating a customized pattern based on a second input to set a state of the pattern,
wherein the state of the pattern comprises one of a location of the pattern, a direction of the pattern, a central axis of the pattern, or a size of the pattern.
